(19) United States
(12) Patent Application Publication
(10) Pub. No.: US 2025/0334812 A1
(43) Pub. Date: Oct. 30, 2025

(54) Methods and Apparatuses for Providing a Holographic Waveguide Display Using Integrated Gratings

(71) Applicant: DigiLens Inc., Sunnyvale, CA (US)

(72) Inventors: Alastair John Grant, San Jose, CA (US); Jonathan David Waldern, Diablo, CA (US); Milan Momcilo Popovich, Leicester (GB); Sihui He, Sunnyvale, CA (US); Edward Lao, Sunnyvale, CA (US); Roger Allen Conley Smith, Sunnyvale, CA (US)

(73) Assignee: DigiLens Inc., Sunnyvale, CA (US)

(21) Appl. No.: 19/009,807

(22) Filed: Jan. 3, 2025

Related U.S. Application Data
(63) Continuation-in-part of application No. 18/942,123, filed on Nov. 8, 2024.
Application No. 18/942,123 is a continuation of application No. 18/328,535, filed on Jun. 2, 2023, now Pat. No. 12,140,764.
Application No. 18/328,535 is a continuation of application No. 17/659,410, filed on Apr. 15, 2022, now abandoned.
Application No. 17/659,410 is a continuation-in-part of application No. 17/328,727, filed on May 24, 2021, now Pat. No. 11,543,594.
Application No. 17/328,727 is a continuation of application No. 16/794,071, filed on Feb. 18, 2020, now abandoned.
(60) Provisional application No. 62/806,665, filed on Feb. 15, 2019.
(60) Provisional application No. 62/813,373, filed on Mar. 4, 2019.
(60) Provisional application No. 63/176,064, filed on Apr. 16, 2021.

(51) Int. Cl. G02B 27/01; F21V 8/00; G02B 6/34

(52) U.S. Cl. CPC G02B 27/0172; G02B 6/0016; G02B 27/0103; G02B 6/34; G02B 2027/0125

(57) ABSTRACT

Systems and methods for providing holographic waveguide display using integrated gratings in accordance with various embodiments of the invention are illustrated. One embodiment includes a waveguide display including a source of light, and a first waveguide including a grating structure including first and second gratings, and an input coupler configured to couple a first field-of-view portion of light, and couple a second field-of-view portion of light, wherein the first grating is configured to provide beam expansion in a first direction for the first field-of-view portion of light, and provide beam expansion in the first direction and beam extraction towards a viewer for the second field-of-view portion of light, the second grating is configured to provide beam expansion in a second direction for the second field-of-view portion of light, and provide beam expansion in the second direction and beam extraction towards a viewer for the first field-of-view portion of light.

### CROSS-REFERENCE TO RELATED APPLICATIONS

The current application is a continuation-in-part of U.S. patent application Ser. No. 18/942,123 entitled “Wide Angle Waveguide Display”, filed Nov. 11, 2024, which is a continuation of U.S. patent application Ser. No. 18/328,535 entitled “Wide Angle Waveguide Display,” filed Jun. 2, 2023 which is a continuation of U.S. application Ser. No. 17/659,410 entitled “Wide Angle Waveguide Display,” filed Apr. 15, 2022, which, claims priority U.S. Provisional Patent Application No. 63/176,064 entitled “Wide Angle Waveguide Display,” filed Apr. 16, 2021, and claims priority as a continuation-in-part of U.S. patent application Ser. No. 17/328,727 entitled “Methods and Apparatuses for Providing a Holographic Waveguide Display Using Integrated Gratings,” filed on May 24, 2021, which is a continuation of U.S. application Ser. No. 16/794,071 entitled “Methods and Apparatuses for Providing a Holographic Waveguide Display Using Integrated Gratings,” filed Feb. 18, 2020, which claims the benefit of and priority under 35 U.S.C. § 119 (e) to U.S. Provisional Patent Application No. 62/806,665 entitled “Methods and Apparatuses for Providing a Color Holographic Waveguide Display Using Overlapping Bragg Gratings,” filed Feb. 15, 2019 and U.S. Provisional Patent Application No. 62/813,373 entitled “Improvements to Methods and Apparatuses for Providing a Color Holographic Waveguide Display Using Overlapping Bragg Gratings,” filed Mar. 4, 2019, the disclosures of which are incorporated herein by reference in their entirety.

### FIELD OF THE INVENTION

The present invention generally relates to waveguide devices and, more specifically, to holographic waveguide displays.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE INVENTION

Systems and methods for providing holographic waveguide display using integrated gratings in accordance with various embodiments of the invention are illustrated. One embodiment includes a waveguide display including a source of light, and a first waveguide including a grating structure including first and second gratings, and an input coupler configured to couple a first field-of-view portion of light from the source of light into the first waveguide and towards the first grating, and couple a second field-of-view portion of light from the source of light into the first waveguide and towards the second grating, wherein the first grating is configured to provide beam expansion in a first direction for the first field-of-view portion of light, and provide beam expansion in the first direction and beam extraction towards a viewer for the second field-of-view portion of light, the second grating is configured to provide beam expansion in a second direction for the second field-of-view portion of light, and provide beam expansion in the second direction and beam extraction towards a viewer for the first field-of-view portion of light, the input coupler, the first grating, and the second grating each includes a grating vector, and the grating vectors of the input coupler, the first grating, and the second grating provide a resultant vector with substantially zero magnitude.

In another embodiment, the first grating includes first and second grating prescriptions, and the second grating includes third and fourth grating prescriptions, wherein the first grating prescription is configured to provide the beam expansion in the first direction for the first field-of-view portion of light, the second grating prescription is configured to provide beam expansion in the first direction and beam extraction towards a viewer for the second field-of-view portion of light, the third grating prescription is configured to provide the beam expansion in the second direction for the second field-of-view portion of light, and the fourth grating prescription is configured to provide the beam expansion in the second direction and beam extraction towards a viewer for the first field-of-view portion of light.

In a further embodiment, the first and second grating prescriptions are at least partially multiplexed, and the third and fourth grating prescriptions are at least partially multiplexed.

In still another embodiment, the first grating at least partially overlaps the second grating.

In a still further embodiment, the first waveguide includes first and second grating layers, the first grating is disposed within the first grating layer, and the second grating is disposed within the second grating layer.

In yet another embodiment, the first waveguide further includes a transparent layer disposed between and adjacent the first and second grating layers.

In a yet further embodiment, the waveguide display further includes a second waveguide, wherein the first waveguide is configured to couple in a first spectral band of light, and the second waveguide is configured to couple in a second spectral band of light.

In another additional embodiment, wherein the input coupler includes an input configuration selected from at least one of an input prism, an input grating, first and second input gratings, and an input grating including two multiplexed grating prescriptions.

In a further additional embodiment, the grating vector of the input coupler has a different magnitude than the grating vector of the first grating.

In another embodiment again, the source of light provides at least two different wavelengths of light.

In a further embodiment again, a method of displaying an image, the method including providing a waveguide display including a first waveguide supporting an input coupler and a grating structure including first and second gratings, wherein the input coupler, the first grating, and the second grating each includes a grating vector, wherein the grating vectors of the input coupler, the first grating, and the second grating provide a resultant vector with substantially zero magnitude, coupling a first field of view portion into the waveguide via the input coupler, coupling a second field-of-view portion into the waveguide via the input coupler, expanding the first field-of-view portion light in a first direction using the first grating, expanding the first field-of-view portion light in a second direction and extracting it from the waveguide using the second grating, expanding the second field-of-view portion light in the second direction using the second grating, and expanding the second field of view portion light in the first direction and extracting it from the waveguide using the first grating.

In still yet another embodiment, the first grating includes first and second grating prescriptions, and the second grating includes third and fourth grating prescriptions, wherein the first field-of-view portion light is expanded in the first direction using the first grating prescription, the second field-of-view portion light is expanded in the first direction and extracted from the waveguide using the second grating prescription, the second field-of-view portion light is expanded in the second direction using the third grating prescription, and the first field-of-view portion light is expanded in the second direction and extracted from the waveguide using the fourth grating prescription.

In a still yet further embodiment, the first and second grating prescriptions are at least partially multiplexed, and the third and fourth grating prescriptions are at least partially multiplexed.

In still another additional embodiment, the first grating at least partially overlaps the second grating.

In a still further additional embodiment, the first waveguide includes first and second grating layers, the first grating is disposed within the first grating layer, and the second grating is disposed within the second grating layer.

In still another embodiment again, the first waveguide further includes a transparent layer disposed between and adjacent the first and second grating layers.

In a still further embodiment again, the waveguide display further includes a second waveguide, wherein the first waveguide is configured to couple in a first spectral band of light, and the second waveguide is configured to couple in a second spectral band of light.

In yet another additional embodiment, the input coupler includes an input configuration selected from at least one of an input prism, an input grating, first and second input gratings, and an input grating comprising two multiplexed grating prescriptions.

In a yet further additional embodiment, the grating vector of the input coupler has a different magnitude than the grating vector of the first grating.

In yet another embodiment again, the source of light provides at least two different wavelengths of light.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a waveguide display in accordance with an embodiment of the invention.

FIG. 2 conceptually illustrates a color waveguide display having two blue-green diffracting waveguides and two green-red diffracting waveguides in accordance with an embodiment of the invention.

FIGS. 3A-3C conceptually illustrate integrated gratings in accordance with various embodiments of the invention.

FIGS. 4A-4C schematically illustrate ray propagation through a grating structure having an input grating and two integrated gratings in accordance with an embodiment of the invention.

FIGS. 5A-5E conceptually illustrate various grating vector configurations in accordance with various embodiments of the invention.

FIG. 6 conceptually illustrates a schematic plan view of a grating architecture having an input grating and integrated gratings in accordance with an embodiment of the invention.

FIG. 7 shows a flow diagram conceptually illustrating a method of displaying an image in accordance with an embodiment of the invention.

FIG. 8 shows a flow diagram conceptually illustrating a method of displaying an image utilizing integrated gratings containing multiple gratings in accordance with an embodiment of the invention.

FIG. 9 conceptually illustrates a profile view of two overlapping waveguide portions implementing integrated gratings in accordance with an embodiment of the invention.

FIG. 10 conceptually illustrates a schematic plan view of a grating architecture having two sets of integrated gratings in accordance with an embodiment of the invention.

FIG. 11 conceptually illustrates a plot of diffraction efficiency versus angle for a waveguide for diffractions occurring at different field-of-view angles in accordance with an embodiment of the invention.

FIG. 12 shows the viewing geometry provided by a waveguide in accordance with an embodiment of the invention.

FIG. 13 conceptually illustrates the field-of-view geometry for a binocular display with binocular overlap between the left and right eye images provided by a waveguide in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Waveguide displays in accordance with various embodiments of the invention can be implemented using many different techniques. Waveguide technology can enable low cost, efficient, and versatile diffractive optical solutions for many different applications. One commonly used waveguide architecture includes an input grating for coupling light from an image source into a TIR path in the waveguide, a fold grating for providing beam expansion in a first direction, and an output grating for providing a second beam expansion in a direction orthogonal to the first direction and extracting the pupil-expanded beam from the waveguide for viewing from an exit pupil or eyebox. While effective at two-dimensional beam expansion and extraction, this arrangement typically demands a large grating area. When used with birefringent gratings, this architecture can also suffer from haze that arises from millions of grating interactions in the fold. A further issue is image nonuniformity due to longer light paths incurring more beam interactions with the substrates of the waveguide. As such, many embodiments of the invention are directed towards wide angle, low cost, efficient, and compact waveguide displays.

In many embodiments, the waveguide display includes at least one input grating and at least two integrated gratings, each capable of performing the functions of traditional fold and output gratings. In further embodiments, a single multiplexed input grating is implemented to provide input light with two bifurcated paths. In other embodiments, two input gratings are implemented to provide bifurcated optical paths. In addition to the different configurations of the input grating(s), the integrated gratings can also be configured in various ways. In some embodiments, the integrated gratings contain crossed grating vectors and can be configured to provide beam expansion in two directions and beam extraction for light coming from the input grating(s). In several embodiments, the integrated gratings are configured as overlapping gratings with crossed grating vectors. The integrated nature of the grating architecture can allow for a compact waveguide display that is suitable for various applications, including but not limited to AR, VR, HUD, and LIDAR applications. As can readily be appreciated, the specific architecture and implementation of the waveguide display can depend on the specific requirements of a given application. For example, in some embodiments, the waveguide display is implemented with integrated gratings to provide a binocular field-of-view of at least 50° diagonal. In further embodiments, the waveguide display is implemented with integrated gratings to provide a binocular field-of-view of at least ˜100° diagonal. Waveguide displays, grating architecture, HPDLC materials, and manufacturing processes in accordance with various embodiments of the invention are discussed below in further detail.

### Optical Waveguide and Grating Structures

Optical structures recorded in waveguides can include many different types of optical elements, such as but not limited to diffraction gratings. Gratings can be implemented to perform various optical functions, including but not limited to coupling light, directing light, and preventing the transmission of light. In many embodiments, the gratings are surface relief gratings that reside on the outer surface of the waveguide. In other embodiments, the grating implemented is a Bragg grating (also referred to as a volume grating), which are structures having a periodic refractive index modulation. Bragg gratings can be fabricated using a variety of different methods. One process includes interferential exposure of holographic photopolymer materials to form periodic structures. Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil.

One class of Bragg gratings used in holographic waveguide devices is the Switchable Bragg Grating (SBG). SBGs can be fabricated by first placing a thin film of a mixture of photopolymerizable monomers and liquid crystal material between substrates. The substrates can be made of various types of materials, such glass and plastics. In many cases, the substrates are in a parallel configuration. In other embodiments, the substrates form a wedge shape. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (ITO). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 us with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition.

In some embodiments, LC can be extracted or evacuated from the SBG to provide a surface relief grating (SRG) that has properties very similar to a Bragg grating due to the depth of the SRG structure (which is much greater than that practically achievable using surface etching and other conventional processes commonly used to fabricate SRGs). The LC can be extracted using a variety of different methods, including but not limited to flushing with isopropyl alcohol and solvents. In many embodiments, one of the transparent substrates of the SBG is removed, and the LC is extracted. In further embodiments, the removed substrate is replaced. The SRG can be at least partially backfilled with a material of higher or lower refractive index. Such gratings offer scope for tailoring the efficiency, angular/spectral response, polarization, and other properties to suit various waveguide applications.

Waveguides in accordance with various embodiments of the invention can include various grating configurations designed for specific purposes and functions. In many embodiments, the waveguide is designed to implement a grating configuration capable of preserving eyebox size while reducing lens size by effectively expanding the exit pupil of a collimating optical system. The exit pupil can be defined as a virtual aperture where only the light rays which pass though this virtual aperture can enter the eyes of a user. In some embodiments, the waveguide includes an input grating optically coupled to a light source, a fold grating for providing a first direction beam expansion, and an output grating for providing beam expansion in a second direction, which is typically orthogonal to the first direction, and beam extraction towards the eyebox. As can readily be appreciated, the grating configuration implemented waveguide architectures can depend on the specific requirements of a given application. In some embodiments, the grating configuration includes multiple fold gratings. In several embodiments, the grating configuration includes an input grating and a second grating for performing beam expansion and beam extraction simultaneously. The second grating can include gratings of different prescriptions, for propagating different portions of the field-of-view, arranged in separate overlapping grating layers or multiplexed in a single grating layer. Furthermore, various types of gratings and waveguide architectures can also be utilized.

In several embodiments, the gratings within each layer are designed to have different spectral and/or angular responses. For example, in many embodiments, different gratings across different grating layers are overlapped, or multiplexed, to provide an increase in spectral bandwidth. In some embodiments, a full color waveguide is implemented using three grating layers, each designed to operate in a different spectral band (red, green, and blue). In other embodiments, a full color waveguide is implemented using two grating layers, a red-green grating layer and a green-blue grating layer. As can readily be appreciated, such techniques can be implemented similarly for increasing angular bandwidth operation of the waveguide. In addition to the multiplexing of gratings across different grating layers, multiple gratings can be multiplexed within a single grating layer—i.e., multiple gratings can be superimposed within the same volume. In several embodiments, the waveguide includes at least one grating layer having two or more grating prescriptions multiplexed in the same volume. In further embodiments, the waveguide includes two grating layers, each layer having two grating prescriptions multiplexed in the same volume. Multiplexing two or more grating prescriptions within the same volume can be achieved using various fabrication techniques. In a number of embodiments, a multiplexed master grating is utilized with an exposure configuration to form a multiplexed grating. In many embodiments, a multiplexed grating is fabricated by sequentially exposing an optical recording material layer with two or more configurations of exposure light, where each configuration is designed to form a grating prescription. In some embodiments, a multiplexed grating is fabricated by exposing an optical recording material layer by alternating between or among two or more configurations of exposure light, where each configuration is designed to form a grating prescription. As can readily be appreciated, various techniques, including those well known in the art, can be used as appropriate to fabricate multiplexed gratings.

In many embodiments, the waveguide can incorporate at least one of: angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, and gratings having spatially varying average refractive index tensors. In some embodiments, the waveguide can incorporate at least one of: a half wave plate, a quarter wave plate, an anti-reflection coating, a beam splitting layer, an alignment layer, a photochromic back layer for glare reduction, and louvre films for glare reduction. In several embodiments, the waveguide can support gratings providing separate optical paths for different polarizations. In various embodiments, the waveguide can support gratings providing separate optical paths for different spectral bandwidths. In a number of embodiments, the gratings can be HPDLC gratings, switching gratings recorded in HPDLC (such switchable Bragg Gratings), Bragg gratings recorded in holographic photopolymer, or surface relief gratings. In many embodiments, the waveguide operates in a monochrome band. In some embodiments, the waveguide operates in the green band. In several embodiments, waveguide layers operating in different spectral bands such as red, green, and blue (RGB) can be stacked to provide a three-layer waveguiding structure. In further embodiments, the layers are stacked with air gaps between the waveguide layers. In various embodiments, the waveguide layers operate in broader bands such as blue-green and green-red to provide two-waveguide layer solutions. In other embodiments, the gratings are color multiplexed to reduce the number of grating layers. Various types of gratings can be implemented. In some embodiments, at least one grating in each layer is a switchable grating.

Waveguides incorporating optical structures such as those discussed above can be implemented in a variety of different applications, including but not limited to waveguide displays. In various embodiments, the waveguide display is implemented with an eyebox of greater than 10 mm with an eye relief greater than 25 mm. In some embodiments, the waveguide display includes a waveguide with a thickness between 2.0-5.0 mm. In many embodiments, the waveguide display can provide an image field-of-view of at least 50° diagonal. In further embodiments, the waveguide display can provide an image field-of-view of at least 70° diagonal. The waveguide display can employ many different types of picture generation units (PGUs). In several embodiments, the PGU can be a reflective or transmissive spatial light modulator such as a liquid crystal on Silicon (LCoS) panel or a micro electromechanical system (MEMS) panel. In a number of embodiments, the PGU can be an emissive device such as an organic light emitting diode (OLED) panel. In some embodiments, an OLED display can have a luminance greater than 4000 nits and a resolution of 4 k×4 k pixels. In several embodiments, the waveguide can have an optical efficiency greater than 10% such that a greater than 400 nit image luminance can be provided using an OLED display of luminance 4000 nits. Waveguides implementing P-diffracting gratings (i.e., gratings with high efficiency for P-polarized light) typically have a waveguide efficiency of 5%-6.2%. Since P-diffracting or S-diffracting gratings can waste half of the light from an unpolarized source such as an OLED panel, many embodiments are directed towards waveguides capable of providing both S-diffracting and P-diffracting gratings to allow for an increase in the efficiency of the waveguide by up to a factor of two. In some embodiments, the S-diffracting and P-diffracting gratings are implemented in separate overlapping grating layers. Alternatively, a single grating can, under certain conditions, provide high efficiency for both p-polarized and s-polarized light. In several embodiments, the waveguide includes Bragg-like gratings produced by extracting LC from HPDLC gratings, such as those described above, to enable high S and P diffraction efficiency over certain wavelength and angle ranges for suitably chosen values of grating thickness (typically, in the range 2-5 μm).

### Optical Recording Material Systems

HPDLC mixtures generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. 1 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element having: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:
R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

### Modulation of Material Composition

High luminance and excellent color fidelity are important factors in AR waveguide displays. In each case, high uniformity across the FOV can be desired. However, the fundamental optics of waveguides can lead to non-uniformities due to gaps or overlaps of beams bouncing down the waveguide. Further non-uniformities may arise from imperfections in the gratings and non-planarity of the waveguide substrates. In SBGs, there can exist a further issue of polarization rotation by birefringent gratings. In applicable cases, the biggest challenge is usually the fold grating where there are millions of light paths resulting from multiple intersections of the beam with the grating fringes. Careful management of grating properties, particularly the refractive index modulation, can be utilized to overcome non-uniformity.

Out of the multitude of possible beam interactions (diffraction or zero order transmission), only a subset contributes to the signal presented at the eye box. By reverse tracing from the eyebox, fold regions contributing to a given field point can be pinpointed. The precise correction to the modulation that is needed to send more into the dark regions of the output illumination can then be calculated. Having brought the output illumination uniformity for one color back on target, the procedure can be repeated for other colors. Once the index modulation pattern has been established, the design can be exported to the deposition mechanism, with each target index modulation translating to a unique deposition setting for each spatial resolution cell on the substrate to be coated/deposited. The resolution of the deposition mechanism can depend on the technical limitations of the system utilized. In many embodiments, the spatial pattern can be implemented to 30 micrometers resolution with full repeatability.

Compared with waveguides utilizing surface relief gratings (SRGs), SBG waveguides implementing manufacturing techniques in accordance with various embodiments of the invention can allow for the grating design parameters that impact efficiency and uniformity, such as but not limited to refractive index modulation and grating thickness, to be adjusted dynamically during the deposition process without the need for a different master. With SRGs where modulation is controlled by etch depth, such schemes would not be practical as each variation of the grating would entail repeating the complex and expensive tooling process. Additionally, achieving the required etch depth precision and resist imaging complexity can be very difficult.

Deposition processes in accordance with various embodiments of the invention can provide for the adjustment of grating design parameters by controlling the type of material that is to be deposited. Various embodiments of the invention can be configured to deposit different materials, or different material compositions, in different areas on the substrate. For example, deposition processes can be configured to deposit HPDLC material onto an area of a substrate that is meant to be a grating region and to deposit monomer onto an area of the substrate that is meant to be a non-grating region. In several embodiments, the deposition process is configured to deposit a layer of optical recording material that varies spatially in component composition, allowing for the modulation of various aspects of the deposited material. The deposition of material with different compositions can be implemented in several different ways. In many embodiments, more than one deposition head can be utilized to deposit different materials and mixtures. Each deposition head can be coupled to a different material/mixture reservoir. Such implementations can be used for a variety of applications. For example, different materials can be deposited for grating and non-grating areas of a waveguide cell. In some embodiments, HPDLC material is deposited onto the grating regions while only monomer is deposited onto the non-grating regions. In several embodiments, the deposition mechanism can be configured to deposit mixtures with different component compositions.

In some embodiments, spraying nozzles can be implemented to deposit multiple types of materials onto a single substrate. In waveguide applications, the spraying nozzles can be used to deposit different materials for grating and non-grating areas of the waveguide. In many embodiments, the spraying mechanism is configured for printing gratings in which at least one the material composition, birefringence, and/or thickness can be controlled using a deposition apparatus having at least two selectable spray heads. In some embodiments, the manufacturing system provides an apparatus for depositing grating recording material optimized for the control of laser banding. In several embodiments, the manufacturing system provides an apparatus for depositing grating recording material optimized for the control of polarization non-uniformity. In several embodiments, the manufacturing system provides an apparatus for depositing grating recording material optimized for the control of polarization non-uniformity in association with an alignment control layer. In a number of embodiments, the deposition workcell can be configured for the deposition of additional layers such as beam splitting coatings and environmental protection layers. Inkjet print heads can also be implemented to print different materials in different regions of the substrate.

As discussed above, deposition processes can be configured to deposit optical recording material that varies spatially in component composition. Modulation of material composition can be implemented in many different ways. In a number of embodiments, an inkjet print head can be configured to modulate material composition by utilizing the various inkjet nozzles within the print head. By altering the composition on a “dot-by-dot” basis, the layer of optical recording material can be deposited such that it has a varying composition across the planar surface of the layer. Such a system can be implemented using a variety of apparatuses including but not limited to inkjet print heads. Similar to how color systems use a palette of only a few colors to produce a spectrum of millions of discrete color values, such as the CMYK system in printers or the additive RGB system in display applications, inkjet print heads in accordance with various embodiments of the invention can be configured to print optical recording materials with varying compositions using only a few reservoirs of different materials. Different types of inkjet print heads can have different precision levels and can print with different resolutions. In many embodiments, a 300 DPI (“dots per inch”) inkjet print head is utilized. Depending on the precision level, discretization of varying compositions of a given number of materials can be determined across a given area. For example, given two types of materials to be printed and an inkjet print head with a precision level of 300 DPI, there are 90,001 possible discrete values of composition ratios of the two types of materials across a square inch for a given volume of printed material if each dot location can contain either one of the two types of materials. In some embodiments, each dot location can contain either one of the two types of materials or both materials. In several embodiments, more than one inkjet print head is configured to print a layer of optical recording material with a spatially varying composition. Although the printing of dots in a two-material application is essentially a binary system, averaging the printed dots across an area can allow for discretization of a sliding scale of ratios of the two materials to be printed. For example, the amount of discrete levels of possible concentrations/ratios across a unit square is given by how many dot locations can be printed within the unit square. As such, there can be a range of different concentration combinations, ranging from 100% of the first material to 100% of the second material. As can readily be appreciated, the concepts are applicable to real units and can be determined by the precision level of the inkjet print head. Although specific examples of modulating the material composition of the printed layer are discussed, the concept of modulating material composition using inkjet print heads can be expanded to use more than two different material reservoirs and can vary in precision levels, which largely depends on the types of print heads used.

Varying the composition of the material printed can be advantageous for several reasons. For example, in many embodiments, varying the composition of the material during deposition can allow for the formation of a waveguide with gratings that have spatially varying diffraction efficiencies across different areas of the gratings. In embodiments utilizing HPDLC mixtures, this can be achieved by modulating the relative concentration of liquid crystals in the HPDLC mixture during the printing process, which creates compositions that can produce gratings with varying diffraction efficiencies when the material is exposed. In several embodiments, a first HPDLC mixture with a certain concentration of liquid crystals and a second HPDLC mixture that is liquid crystal-free are used as the printing palette in an inkjet print head for modulating the diffraction efficiencies of gratings that can be formed in the printed material. In such embodiments, discretization can be determined based on the precision of the inkjet print head. A discrete level can be given by the concentration/ratio of the materials printed across a certain area. In this example, the discrete levels range from no liquid crystal to the maximum concentration of liquid crystals in the first PDLC mixture.

The ability to vary the diffraction efficiency across a waveguide can be used for various purposes. A waveguide is typically designed to guide light internally by reflecting the light many times between the two planar surfaces of the waveguide. These multiple reflections can allow for the light path to interact with a grating multiple times. In many embodiments, a layer of material can be printed with varying composition of materials such that the gratings formed have spatially varying diffraction efficiencies to compensate for the loss of light during interactions with the gratings to allow for a uniform output intensity. For example, in some waveguide applications, an output grating is configured to provide exit pupil expansion in one direction while also coupling light out of the waveguide. The output grating can be designed such that when light within the waveguide interact with the grating, only a percentage of the light is refracted out of the waveguide. The remaining portion continues in the same light path, which remains within TIR and continues to be reflected within the waveguide. Upon a second interaction with the same output grating again, another portion of light is refracted out of the waveguide. During each refraction, the amount of light still traveling within the waveguide decreases by the amount refracted out of the waveguide. As such, the portions refracted at each interaction gradually decreases in terms of total intensity. By varying the diffraction efficiency of the grating such that it increases with propagation distance, the decrease in output intensity along each interaction can be compensated, allowing for a uniform output intensity.

Varying the diffraction efficiency can also be used to compensate for other attenuation of light within a waveguide. All objects have a degree of reflection and absorption. Light trapped in TIR within a waveguide are continually reflected between the two surfaces of the waveguide. Depending on the material that makes up the surfaces, portions of light can be absorbed by the material during each interaction. In many cases, this attenuation is small, but can be substantial across a large area where many reflections occur. In many embodiments, a waveguide cell can be printed with varying compositions such that the gratings formed from the optical recording material layer have varying diffraction efficiencies to compensate for the absorption of light from the substrates. Depending on the substrates, certain wavelengths can be more prone to absorption by the substrates. In a multi-layered waveguide design, each layer can be designed to couple in a certain range of wavelengths of light. Accordingly, the light coupled by these individual layers can be absorbed in different amounts by the substrates of the layers. For example, in a number of embodiments, the waveguide is made of a three-layered stack to implement a full color display, where each layer is designed for one of red, green, and blue. In such embodiments, gratings within each of the waveguide layers can be formed to have varying diffraction efficiencies to perform color balance optimization by compensating for color imbalance due to loss of transmission of certain wavelengths of light.

In addition to varying the liquid crystal concentration within the material in order to vary the diffraction efficiency, another technique includes varying the thickness of the waveguide cell. This can be accomplished through the use of spacers. In many embodiments, spacers are dispersed throughout the optical recording material for structural support during the construction of the waveguide cell. In some embodiments, different sizes of spacers are dispersed throughout the optical recording material. The spacers can be dispersed in ascending order of sizes across one direction of the layer of optical recording material. When the waveguide cell is constructed through lamination, the substrates sandwich the optical recording material and, with structural support from the varying sizes of spacers, create a wedge-shaped layer of optical recording material. spacers of varying sizes can be dispersed similar to the modulation process described above. Additionally, modulating spacer sizes can be combined with modulation of material compositions. In several embodiments, reservoirs of HPDLC materials each suspended with spacers of different sizes are used to print a layer of HPDLC material with spacers of varying sizes strategically dispersed to form a wedge-shaped waveguide cell. In a number of embodiments, spacer size modulation is combined with material composition modulation by providing a number of reservoirs equal to the product of the number of different sizes of spacers and the number of different materials used. For example, in one embodiment, the inkjet print head is configured to print varying concentrations of liquid crystal with two different spacer sizes. In such an embodiment, four reservoirs can be prepared: a liquid crystal-free mixture suspension with spacers of a first size, a liquid crystal-free mixture-suspension with spacers of a second size, a liquid crystal-rich mixture-suspension with spacers of a first size, and a liquid crystal-rich mixture-suspension with spacers of a second size. Further discussion regarding material modulation can be found in U.S. application Ser. No. 16/203,071 filed Nov. 18, 2018 entitled “SYSTEMS AND METHODS FOR MANUFACTURING WAVEGUIDE CELLS.” The disclosure of U.S. application Ser. No. 16/203,491 is hereby incorporated by reference in its entirety for all purposes.

### Multi-Layered Waveguide Fabrication

Waveguide manufacturing in accordance with various embodiments of the invention can be implemented for the fabrication of multi-layered waveguides. Multi-layered waveguides refer to a class of waveguides that utilizes two or more layers having gratings or other optical structures. Although the discussions below may pertain to gratings, any type of holographic optical structure can be implemented and substituted as appropriate. Multi-layered waveguides can be implemented for various purposes, including but not limited to improving spectral and/or angular bandwidths. Traditionally, multi-layered waveguides are formed by stacking and aligning waveguides having a single grating layer. In such cases, each grating layer is typically bounded by a pair of transparent substrates. To maintain the desired total internal reflection characteristics, the waveguides are usually stacked using spacers to form air gaps between the individual waveguides.

In contrast to traditional stacked waveguides, many embodiments of the invention are directed to the manufacturing of multi-layered waveguides having alternating substrate layers and grating layers. Such waveguides can be fabricated with an iterative process capable of sequentially forming grating layers for a single waveguide. In several embodiments, the multi-layered waveguide is fabricated with two grating layers. In a number of embodiments, the multi-layered waveguide is fabricated with three grating layers. Any number of grating layers can be formed, limited by the tools utilized and/or waveguide design. Compared to traditional multi-layered waveguides, this allows for a reduction in thickness, materials, and costs as fewer substrates are needed. Furthermore, the manufacturing process for such waveguides allow for a higher yield in production due to simplified alignment and substrate matching requirements.

Manufacturing processes for multi-layered waveguides having alternating transparent substrate layers and grating layers in accordance with various embodiments of the invention can be implemented using a variety of techniques. In many embodiments, the manufacturing process includes depositing a first layer of optical recording material onto a first transparent substrate. Optical recording material can include various materials and mixtures, including but not limited to HPDLC mixtures and any of the material formulations discussed in the sections above. Similarly, any of a variety of deposition techniques, such as but not limited to spraying, spin coating, inkjet printing, and any of the techniques described in the sections above, can be utilized. Transparent substrates of various shapes, thicknesses, and materials can be utilized. Transparent substrates can include but are not limited to glass substrates and plastic substrates. Depending on the application, the transparent substrates can be coated with different types of films for various purposes. Once the deposition process is completed, a second transparent substrate can then be placed onto the deposited first layer of optical recording material. In some embodiments, the process includes a lamination step to form the three-layer composite into a desired height/thickness. An exposure process can be implemented to form a set of gratings within the first layer of optical recording material. Exposure processes, such as but not limited to single-beam interferential exposure and any of the other exposure processes described in the sections above, can be utilized. In essence, a single-layered waveguide is now formed. The process can then repeat to add on additional layers to the waveguide. In several embodiments, a second layer of optical recording material is deposited onto the second transparent substrate. A third transparent substrate can be placed onto the second layer of optical recording material. Similar to the previous steps, the composite can be laminated to a desired height/thickness. A second exposure process can then be performed to form a set of gratings within the second layer of optical recording material. The result is a waveguide having two grating layers. As can readily be appreciated, the process can continue iteratively to add additional layers. The additional optical recording layers can be added onto either side of the current laminate. For instance, a third layer of optical recording material can be deposited onto the outer surface of either the first transparent substrate or the third transparent substrate.

In many embodiments, the manufacturing process includes one or more post processing steps. Post processing steps such as but not limited to planarization, cleaning, application of protective coats, thermal annealing, alignment of LC directors to achieve a desired birefringence state, extraction of LC from recorded SBGs and refilling with another material, etc. can be carried out at any stage of the manufacturing process. Some processes such as but not limited to waveguide dicing (where multiple elements are being produced), edge finishing, AR coating deposition, final protective coating application, etc. are typically carried out at the end of the manufacturing process.

In many embodiments, spacers, such as but not limited to beads and other particles, are dispersed throughout the optical recording material to help control and maintain the thickness of the layer of optical recording material. The spacers can also help prevent the two substrates from collapsing onto one another. In some embodiments, the waveguide cell is constructed with an optical recording layer sandwiched between two planar substrates. Depending on the type of optical recording material used, thickness control can be difficult to achieve due to the viscosity of some optical recording materials and the lack of a bounding perimeter for the optical recording layer. In a number of embodiments, the spacers are relatively incompressible solids, which can allow for the construction of waveguide cells with consistent thicknesses. The spacers can take any suitable geometry, including but not limited to rods and spheres. The size of a spacer can determine a localized minimum thickness for the area around the individual spacer. As such, the dimensions of the spacers can be selected to help attain the desired optical recording layer thickness. The spacers can take any suitable size. In many cases, the sizes of the spacers range from 1 to 30 μm. The spacers can be made of any of a variety of materials, including but not limited to plastics (e.g., divinylbenzene), silica, and conductive materials. In several embodiments, the material of the spacers is selected such that its refractive index does not substantially affect the propagation of light within the waveguide cell.

In many embodiments, the first layer of optical recording material is incorporated between the first and second transparent substrates using vacuum filling methods. In a number of embodiments, the layer of optical recording materials is separated in different sections, which can be filled or deposited as appropriate depending on the specific requirements of a given application. In some embodiments, the manufacturing system is configured to expose the optical recording material from below. In such embodiments, the iterative multi-layered fabrication process can include turning over the current device such that the exposure light is incident on a newly deposited optical recording layer before it is incident on any formed grating layers.

In many embodiments, the exposing process can include temporarily “erasing” or making transparent the previously formed grating layer such that they will not interfere with the recording process of the newly deposited optical recording layer. Temporarily “erased” gratings or other optical structures can behave similar to transparent materials, allowing light to pass through without affecting the ray paths. Methods for recording gratings into layers of optical recording material using such techniques can include fabricating a stack of optical structures in which a first optical recording material layer deposited on a substrate is exposed to form a first set of gratings, which can be temporarily erased so that a second set of gratings can be recorded into a second optical recording material layer using optical recording beams traversing the first optical recording material layer. Although the recording methods are discussed primarily with regards to waveguides with two grating layers, the basic principle can be applied to waveguides with more than two grating layers.

Multi-layered waveguide fabrication processes incorporating steps of temporarily erasing a grating structure can be implemented in various ways. Typically, the first layer is formed using conventional methods. The recording material utilized can include material systems capable of supporting optical structures that can be erased in response to a stimulus. In embodiments in which the optical structure is a holographic grating, the exposure process can utilize a crossed-beam holographic recording apparatus. In a number of embodiments, the optical recording process uses beams provided by a master grating, which may be a Bragg hologram recorded in a photopolymer or an amplitude grating. In some embodiments, the exposure process utilizes a single recording beam in conjunction with a master grating to form an interferential exposure beam. In addition to the processes described, other industrial processes and apparatuses currently used in the field to fabricate holograms can be used.

Once a first set of gratings is recorded, additional material layers can be added similar to the processes described above. During the exposure process of any material layer after the first material layer, an external stimulus can be applied to any previously formed gratings to render them effectively transparent. The effectively transparent grating layers can allow for light to pass through to expose the new material layer. External stimulus/stimuli can include optical, thermal, chemical, mechanical, electrical, and/or magnetic stimuli. In many embodiments, the external stimulus is applied at a strength below a predefined threshold to produce optical noise below a predefined level. The specific predefined threshold can depend on the type of material used to form the gratings. In some embodiments, a sacrificial alignment layer applied to the first material layer can be used to temporarily erase the first set of gratings. In some embodiments, the strength of the external stimulus applied to the first set of gratings is controlled to reduced optical noise in the optical device during normal operation. In several embodiments, the optical recording material further includes an additive for facilitating the process of erasing the gratings, which can include any of the methods described above. In a number of embodiments, a stimulus is applied for the restoration of an erased layer.

The clearing and restoration of a recorded layer described in the process above can be achieved using many different methods. In many embodiments, the first layer is cleared by applying a stimulus continuously during the recording of the second layer. In other embodiments, the stimulus is initially applied, and the grating in the cleared layer can naturally revert to its recorded state over a timescale that allows for the recording of the second grating. In other embodiments, the layer stays cleared after application of an external stimulus and reverts in response to another external stimulus. In several embodiments, the restoration of the first optical structure to its recorded state can be carried out using an alignment layer or an external stimulus. An external stimulus used for such restoration can be any of a variety of different stimuli, including but not limited to the stimulus/stimuli used to clear the optical structure. Depending on the composition material of the optical structure and layer to be cleared, the clearing process can vary. Further discussion regarding the multi-layered waveguide fabrication utilizing external stimuli can be found in U.S. application Ser. No. 16/522,491 filed Jul. 25, 2019 entitled “Systems and Methods for Fabricating a Multilayer Optical Structure.” The disclosure of U.S. application Ser. No. 16/522,491 is hereby incorporated by reference in its entirety for all purposes.

### Waveguides Incorporating Integrated Gratings

Waveguides in accordance with various embodiments of the invention can include different grating configurations. In many embodiments, the waveguide includes at least one input coupler and at least two integrated gratings. In some embodiments, at least two integrated gratings can be implemented to work in combination to provide beam expansion and beam extraction for light coupled into the waveguide by the input coupler. Multiple integrated gratings can be implemented by overlapping integrated gratings across different grating layers or by multiplexing the integrated gratings. In a number of embodiments, the integrated gratings are partially overlapped or multiplexed. Multiplexed gratings can include the superimposition of at least two gratings having different grating prescriptions within the same volume. Gratings having different grating prescriptions can have different grating vectors and/or grating slant with respect to the waveguide's surface. The magnitude of the grating vector of a grating can be defined as the inverse of the grating period while its direction can be defined as the direction orthogonal to the fringes of the grating.

In several embodiments, an integrated can be implemented to perform both beam expansion and beam extraction. An integrated grating can be implemented with one or more grating prescriptions. In a number of embodiments, the integrated grating is implemented with at least two grating prescriptions. In further embodiments, the integrated grating is implemented with at least three grating prescriptions. In many embodiments, two grating prescriptions within the integrated grating have similar clock angles. In some embodiments, the two grating prescriptions have different slant angles. An integrated grating in accordance with various embodiments of the invention can be implemented using a variety of types of gratings, such as but not limited to SRGs, SBGs, holographic gratings, and other types of gratings including those described in the sections above. In a number of embodiments, the integrated grating includes two surface relief gratings. In other embodiments, the integrated grating includes two holographic gratings.

The integrated grating can include at least two grating prescriptions that are at least partially overlapped or multiplexed. In further embodiments, the integrate grating includes at least two grating prescriptions that are fully overlapped or multiplexed. In a number of embodiments, the integrated grating includes multiplexed or overlapping gratings that have different sizes and/or shapes—i.e., one grating may be larger than the other, resulting in only partial multiplexing of the larger grating. As can readily be appreciated, various multiplexed and overlapping configurations may be implemented as appropriate depending on the specific requirements of a given application. Although the discussions below may describe configurations as implementing multiplexed or overlapping gratings, such gratings can be substituted for one another as appropriate depending on the application. In several embodiments, the integrated gratings are implemented by a combination of both multiplexed and overlapping gratings. For example, two or more sets of multiplexed gratings can be overlapped across two or more grating layers.

Integrated gratings in accordance with various embodiments of the invention can be utilized for various purposes including but not limited to implementing full color waveguides and addressing some key problems in conventional waveguide architectures. Other advantages include reduced material and waveguide refractive index requirements and reduced waveguide dimensions resulting from the overlapping and/or multiplexing nature of the integrated gratings. Such configurations can allow for large field-of-view waveguides, which would ordinarily incur unacceptable increases in waveguide form factor and refractive index requirements. In many embodiments, a waveguide is implemented with at least one substrate having a low refractive index. In some embodiments, the waveguide is implemented with a substrate having a refractive index of lower than 1.8. In further embodiments, the waveguide is implemented with a substrate having a refractive index of not more than ˜1.5.

Integrated gratings that can provide beam expansion and beam extraction—i.e., the functions of conventional fold and output gratings—can result in a much smaller grating area, enabling a small form factor and lower fabrication cost. By integrating the functions of beam expansion and extraction, instead of performing them serially as in traditional waveguides, beam expansion and extraction can be accomplished with ˜50% of the grating interactions normally required, cutting down haze in the same proportion in the case of birefringent gratings. A further advantage is that, as a result of the greatly shortened light paths, the number of beam bounces at glass/air interface(s) is reduced, rendering the output image less sensitive to substrate nonuniformities. This can enable higher quality images and the potential to use less expensive, lower specification substrates.

In many embodiments, the grating vectors of the input coupler and integrated gratings are arranged to provide a substantially zero resultant vector. The grating vectors of the input coupler and integrated gratings can be arranged to form a triangular configuration. In several embodiments, the grating vectors can be arranged in an equilateral triangular configuration. In some embodiments, the grating vectors can be arranged in an isosceles triangular configuration where at least two grating vectors have equal magnitudes. In further embodiments, the grating vectors are arranged in an isosceles right triangular configuration. In a number of embodiments, the grating vectors are arranged in a scalene triangular configuration. Another waveguide architecture includes integrated diffractive elements with grating vectors aligned in the same direction for providing horizontal expansion for one set of angles and extraction for a separate set of angles. In several embodiments, one or more of the integrated gratings are asymmetrical in their general shape. In some embodiments, one or more of the integrated gratings has at least one axis of symmetry in their general shape. In a number of embodiments, the gratings are designed to sandwich an electro-active material, enabling switching between clear and diffracting states for certain types of gratings such as but not limited to HPDLC gratings. The gratings can be a surface relief or a holographic type.

In many embodiments, a waveguide supporting at least one input coupler and first and second integrated gratings is implemented. The grating structures can be implemented in single- or multi-layered waveguide designs. In single-layered designs, the integrated gratings can be multiplexed. In embodiments where each integrated grating contains at least two multiplexed gratings, the multiplexed integrated gratings can contain at least four multiplexed gratings. As described above, any individual multiplexed grating can be partially or completely multiplexed with the other gratings. In some embodiments, a multi-layered waveguide is implemented with overlapping integrated gratings. In further embodiments, the integrated gratings are partially overlapped. Each of the integrated gratings can be a separate grating or multiplexed gratings.

In many embodiments, the waveguide architecture is designed to couple the input light into two bifurcated paths using an input coupler. Such configurations can be implemented in various ways. In some embodiments, a multiplexed input grating is implemented to couple input light into two bifurcated paths. In other embodiments, two input gratings are implemented to separately couple input light into two bifurcated paths. The two input gratings can be implemented in the same layer or separately in two layers. In a number of embodiments, two overlapping or partially overlapping input gratings are implemented to couple input light into two bifurcated paths. In many embodiments, the input coupler includes a prism. In further embodiments, the input coupler includes a prism and any of the input grating configuration described above.

In addition to various input coupler architectures, the first and second integrated gratings can be implemented in a variety of configurations. Integrated gratings in accordance with various embodiments of the invention can be incorporated into waveguides to perform the dual function of two-dimensional beam expansion and beam extraction. In several embodiments, the first and second integrated gratings are crossed gratings. As described above, some waveguide architectures include designs in which input light is coupled into two bifurcated paths. In such designs, the two bifurcated paths are each directed towards a different integrated grating. As can readily be appreciated, such configurations can be designed to bifurcate the input light based on various light characteristics, including but not limited to angular and spectral bandwidths. In some embodiments, light can be bifurcated based on polarization states—e.g., input unpolarized light can be bifurcated into S and P polarization paths. In many embodiments, each of the integrated gratings performs either beam expansion in a first direction or beam expansion in a second direction different from the first direction according to the field-of-view portion being propagated through the waveguide. The first and second directions can be orthogonal to one another. In other embodiments, the first and second directions are not orthogonal to one another. Each integrated grating can provide expansion of the light in a first dimension while directing the light towards the other integrated grating, which provides expansion of the light in a second dimension and extraction. For example, many grating architectures in accordance with various embodiments of the invention include an input configuration for bifurcating input light into first and second portions of light. A first integrated grating can be configured to provide beam expansion in a first direction for the first and second portions of light and to provide beam extraction for the second portion of light. Conversely, the second integrated grating can be configured to provide beam expansion in a second direction for the first and second portions of light and to provide beam extraction for the first portion of light.

In a number of embodiments, the first integrated grating includes multiplexed first and second grating prescriptions, and the second integrated grating includes multiplexed third and fourth grating prescriptions. In such embodiments, the first grating prescription can be configured to provide beam expansion in a first direction for the first portion of light and to redirect the expanded light towards the fourth grating prescription. The second grating prescription can be configured to provide beam expansion in the first direction for the second portion of light and to extract the light out of the waveguide. The third grating prescription can be configured to provide beam expansion in a second direction for the second portion of light and to redirect the expanded light towards the second grating prescription. The fourth grating prescription can be configured to provide beam expansion in the second direction for the first portion of light and to extract the light out of the waveguide. As can readily be appreciated, the integrated gratings can be implemented with overlapping grating prescriptions instead of multiplexed grating prescriptions. In many embodiments, the first and second grating prescriptions have the same clock angle but different grating slants. In some embodiments, the third and fourth grating prescriptions have the same clock angle, which is different from the clock angles of the first and second grating prescriptions. In a number of embodiments, the first, second, third, and fourth grating prescriptions all have different clock angles. In several embodiments, the first, second, third, and fourth grating prescriptions all have different grating periods. In a number of embodiments, the first and third grating prescriptions have the same grating period, and the second and fourth grating prescriptions have the same grating period.

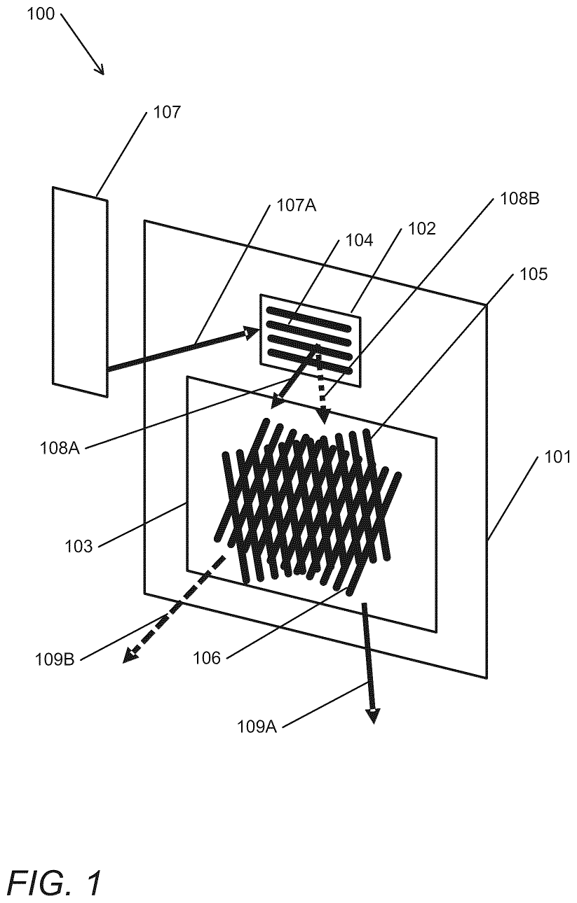

FIG. 1 conceptually illustrates a waveguide display in accordance with an embodiment of the invention. As shown, the apparatus 100 includes a waveguide 101 supporting an input grating 102 and a grating structure 103. Each grating can be characterized by a grating vector defining the orientation of the grating fringes in the plane of the waveguide. A grating can also be characterized by a K-vector in 3D space, which in the case of a Bragg grating is defined as the vector normal to the grating fringes. The waveguide reflecting surfaces are parallel to the XY plane of the Cartesian reference frame inset into the drawing. In some embodiments, the X and Y axes can correspond to global horizontal and vertical axes in the reference frame of a user of the display.

In the illustrative embodiment of FIG. 1, the input grating 102 includes a Bragg grating 104. In other embodiments, the input grating 102 is a surface relief grating. The input grating 102 can be implemented to bifurcate input light into two different portions. In further embodiments, the input grating 102 includes two multiplexed gratings having different grating prescriptions. In other embodiments, the input grating 102 includes two overlaid surface relief gratings. The grating structure 103 includes two effective gratings 105,106 that have different grating vectors. The gratings 105,106 can be integrated gratings implemented as surface relief gratings or volume gratings. In many embodiments, the gratings 105,106 are multiplexed in a single layer. In several embodiments, the waveguide 101 provides two effective gratings at all points across the grating structure 103 by overlaying more than two separated gratings in the grating structure. For ease of clarity, the gratings 105,106 that form the grating structure 103 will be referred to as first and second integrated gratings since their role in the grating structure includes providing beam expansion by changing the direction of the guided beam in the plane of the waveguide and beam extraction. In various embodiments, the integrated gratings 105,106 perform two-dimensional beam expansion and extraction of light from the waveguide 101. The field-of-view coupled into the waveguide can be partitioned into first and second portions, which can be bifurcated as such by the input grating 102. In many embodiments, the first and second portions correspond to positive and negative angles, vertically or horizontally. In some embodiments, the first and second portions may overlap in angle space. In a number of embodiments, the first portion of the field-of-view is expanded in a first direction by the first integrated grating and, in a parallel operation, expanded in a second direction and extracted by the second integrated grating. When a ray interacts with a grating fringe, some of the light that meets the Bragg condition is diffracted while non-diffracted light proceeds along its TIR path up to the next fringe, continuing the expansion and extraction process. Considering next the second portion of the field-of-view, the role of the gratings is reversed such that the second portion of the field is expanded in the second direction by the second integrated grating and expanded in the first direction and extracted by the first integrated grating.

In many embodiments, the integrated gratings 105,106 in the grating structure 103 can be asymmetrically disposed. In some embodiments, the integrated gratings 105,106 have grating vectors of different magnitudes. In several embodiments, the input grating 102 can have a grating vector offset from the Y-axis. In a number of embodiments, it is desirable that the vector combination of the grating vectors of the input grating 102 and the integrated gratings 105,106 in the grating structures 103 gives a resultant vector of substantially zero magnitude. As described above, the grating vectors can be arranged in an equilateral, isosceles, or scalene triangular configuration. Depending on the application, certain configurations may be more desirable.

In many embodiments, at least one grating parameter selected from the group of grating vector direction, K-vector direction, grating refractive index modulation, and grating spatial frequency can vary spatially across at least one grating implemented in the waveguide for the purposes of optimizing angular bandwidth, waveguide efficiency, and output uniformity to increase the angular response and/or efficiency. In some embodiments, at least one of the gratings implemented in the waveguide can employ rolled K-vectors—i.e., spatially varying K-vectors. In several embodiments, the spatial frequencies of the grating(s) are matched to overcome color dispersion.

The apparatus 100 of FIG. 1 further includes an input image generator. In the illustrative embodiment, the input image generator includes a laser scanning projector 107 that provides a scanned beam 107A over a field-of-view that is coupled into total internal reflection paths (TIR paths) (108A, 108B, for example) in the waveguide by the input grating 102 and is directed towards the integrated gratings 105,106 to be expanded and extracted (as shown by rays 109A, 109B, for example). In some embodiments, the laser projector 107 is configured to inject a scanned beam into the waveguide. In several embodiments, the laser projector 107 can have a scan pattern modified to compensate for optical distortions in the waveguide. In a number of embodiments, the laser scanning pattern and/or grating prescriptions in the input grating 102 and grating structure 103 can be modified to overcome illumination banding. In various embodiments, the laser scanning projector 107 can be replaced by an input image generator based on a microdisplay illuminated by a laser or an LED. In many embodiments, the input image can be provided by an emissive display. A laser projector can offer the advantages of improved color gamut, higher brightness, wider field-of-view, high resolution, and a very compact form factor. In some embodiments, the apparatus 100 can further include a despeckler. In further embodiments, the despeckler can be implemented as a waveguide device. Although FIG. 1 shows a specific waveguide application implementing integrated gratings, such structures and grating architectures can be utilized for various applications. In a number of embodiments, a waveguide having integrated gratings can be implemented in a single grating layer for a full color application. In many embodiments, more than one grating layer implementing integrated gratings are implemented. Such configurations can be implemented to provide wider angular or spectral bandwidth operation. In some embodiments, a multi-layered waveguide is implemented to provide a full color application. In several embodiments, a multi-layered waveguide is implemented to provide a wider field-of-view. In many embodiments, a full color waveguide having at least a ˜50° diagonal field-of-view is implemented using integrated gratings. In some embodiments, a full color waveguide having at least a ˜100° diagonal field-of-view is implemented using integrated gratings.

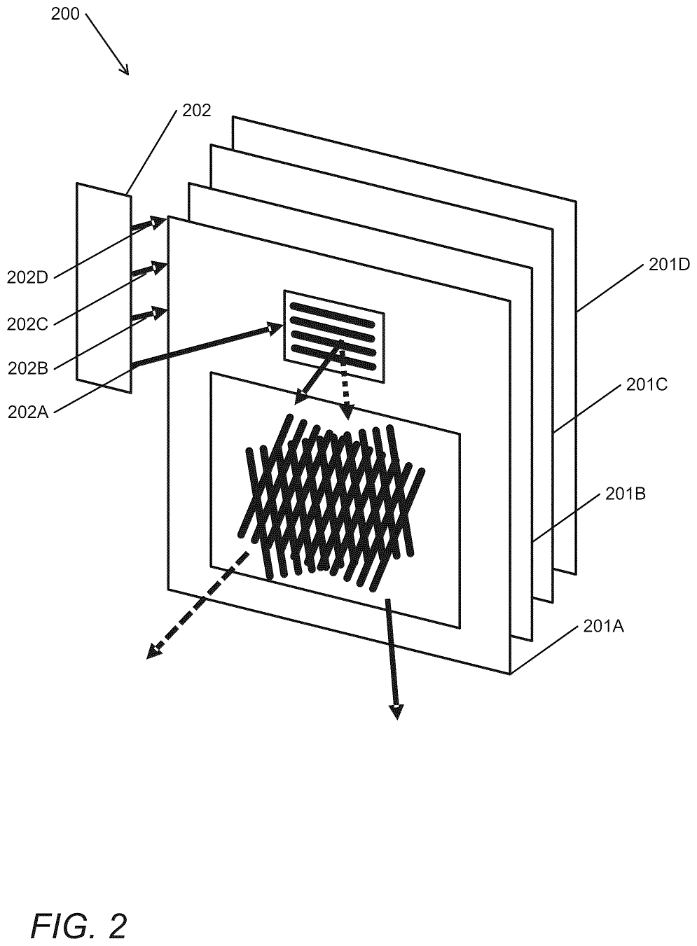

FIG. 2 conceptually illustrates a color waveguide display having two blue-green diffracting waveguides and two green-red diffracting waveguides in accordance with an embodiment of the invention. FIG. 2 schematically illustrates an apparatus 200 with an architecture similar to that of FIG. 1 but includes the use of four stacked waveguides 201A-201D, including two blue-green diffracting waveguides and two green-red diffracting waveguides. As shown, the apparatus 200 includes a laser scanning projector 202 that provides scanning beams 202A-202D. In the illustrative embodiment, the waveguides providing each color band can be configured to propagate different field-of-view portions. For example, in some embodiments, each of the waveguides operating in a given color band provides a field-of-view of 35° h×35° v (50° diagonal), yielding 70° h×35° v (78° diagonal) field-of-view for each color band when the two fields of view are combined. In many embodiments, the scanning beams can be generated using red, green, and blue laser emitters with each light of two laser wavelengths selected from red, green, and blue being injected into each waveguide according to the color band intended to be propagated by the waveguide. The laser beam intensities can be modulated for the purposed of color balancing. The stacked waveguides can be arranged in any order. In several embodiments, consideration of factors such as but not limited to color crosstalk can influence the stack order. In a number of embodiments, the integrated gratings of one waveguide are partially or completely overlapped with the integrated gratings of another waveguide. As described above, the integrated gratings can be implemented in various configurations. In some embodiments, the integrated gratings are implemented across more than one grating layer. In several embodiments, each of the integrated gratings includes two multiplexed grating prescriptions.

In many embodiments, the optical geometrical requirements for combining waveguide paths for more than one field-of-view or color band can dictate an asymmetric arrangement of the gratings used in the input grating(s) and the integrated gratings. In other words, the grating vectors of the input grating and the integrated gratings are not equilaterally disposed or symmetrically disposed about the Y axis.

Although FIGS. 1 and 2 show specific configurations of waveguide architectures, various structures can be implemented as appropriate depending on the specific requirements of a given application. In some embodiments, a six-layered waveguide is implemented for full color applications. The six-layered waveguide can be implemented with three pairs of layers configured for color bands of red, green, and blue, respectively. In such embodiments, waveguides within each pair can be configured for different field-of-view portions.

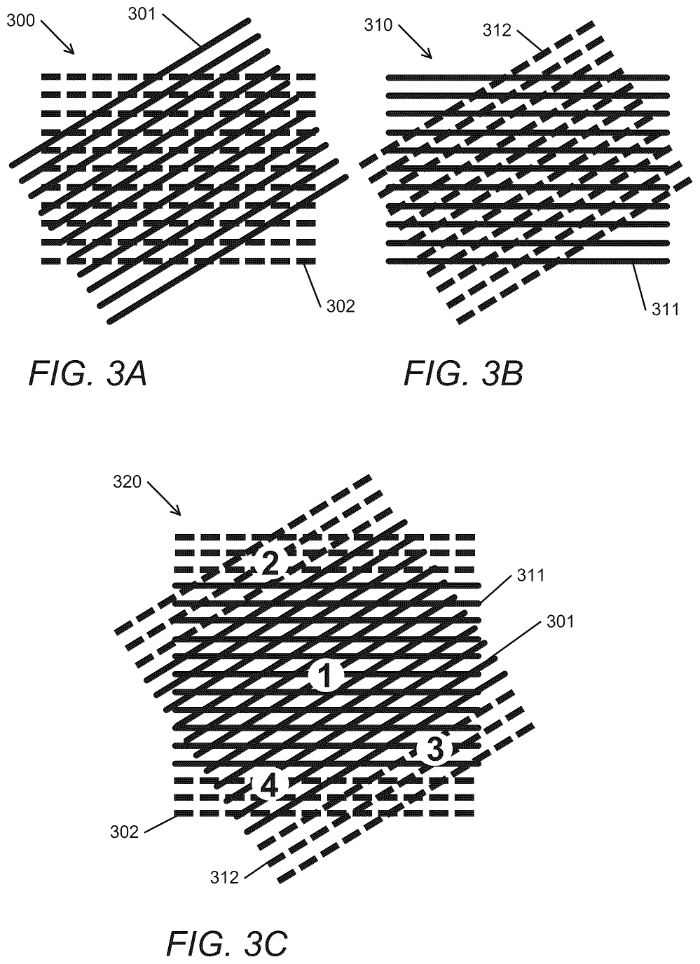

In some embodiments, to perform beam expansion and extraction, the waveguide is designed such that each point of interaction of a ray with a grating structure occurs in a region of overlapping effective gratings. In a non-fully overlapped grating configuration, the grating structures will have regions in which the first and second effective gratings only partially overlap such that some rays interact with only one of the effective gratings. In many embodiments, the grating structures are formed from two multiplexed gratings. The first of the multiplexed grating 300, which is shown in FIG. 3A, multiplexes a first effective grating 301 with one 302 having a different effective grating vector (or clock angle). The second multiplexed grating 310, which is shown in FIG. 3B, multiplexes a second effective grating 311 with one 312 having a different effective grating vector. FIGS. 3A-3B are intended to illustrate the relative orientations of the multiplexed gratings and do not represent the shapes of the gratings as implemented. In some embodiments, the gratings 301,302 and 311,312 may differ in shape from each other. In the embodiments of FIGS. 3A-3B, the grating vector (clock angle) of the second multiplexed grating is identical to the first grating vector of the first multiplexed grating. Likewise, the grating vector of the first multiplexed grating is identical to the second grating vector of the second multiplexed grating. Turning now to FIG. 3C, it should be apparent that when the gratings are overlapped 320, there are two gratings of different clock angles at any point in the grating structures (e.g., in the regions of partial overlap-labeled by numerals 2-4 in FIG. 3C) of the effective gratings. In the regions of full overlap (labelled by numeral 1 in FIG. 3C) of the effective gratings, there will be four gratings overlapping any point in the grating structures. However, in such regions, each pair of gratings having the same clock angle results in only two overlapping effective gratings. It should be appreciated from the above description that, in many embodiments, the two pairs of multiplexed gratings could be implemented as one multiplexed grating formed from the four gratings 301,302 and 311, 312.

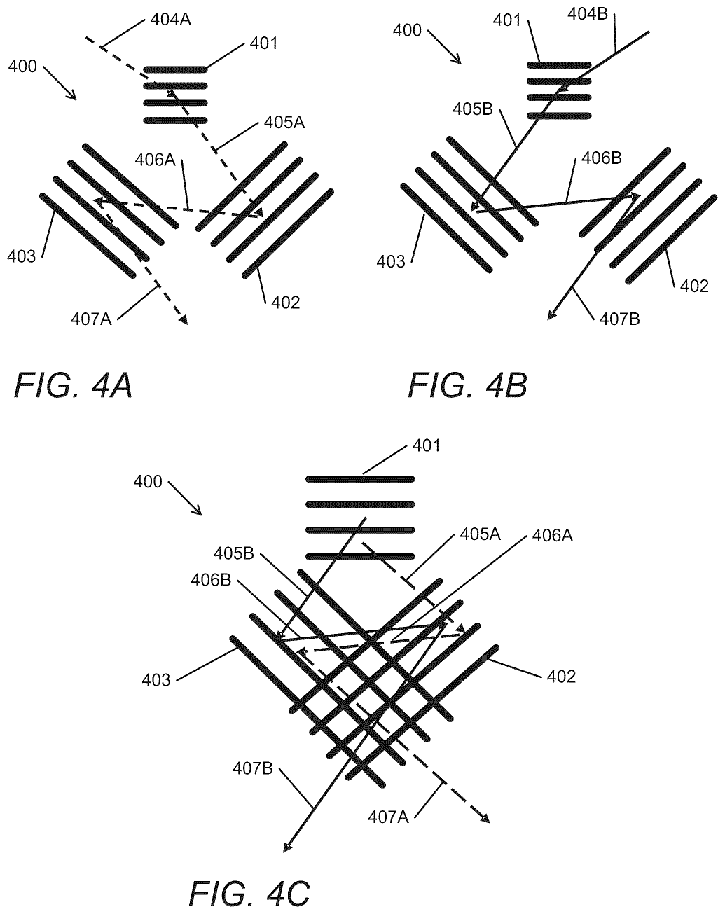

FIGS. 4A-4C schematically illustrate ray propagation through a grating structure 400 having an input grating 401 and two integrated gratings 402,403 in accordance with an embodiment of the invention. The ray propagation is illustrated using unfolded ray paths to clarify the interaction between the rays and gratings. As shown in the schematic diagram of FIG. 4A, light from a first portion of the FOV shows a ray 404A coupled into a TIR path in the waveguide by the input grating 401, a TIR ray 405A leading to the first integrated grating 402, a TIR ray 406A diffracted by the first integrated grating 403 (which also provides beam expansion in a first direction), and a ray 407A diffracted out of the waveguide by the second integrated grating 403 (which also provides beam expansion in a second direction). Turning now to the propagation of the second portion of the FOV, which is shown in FIG. 4B, the ray path includes a ray 404B coupled into a TIR path in the waveguide by the input grating 401, a TIR ray 405B leading to the second integrated grating 403, a TIR ray 406B diffracted by the second integrated grating 403 (which also provides beam expansion in the second direction), and a TIR ray 407B diffracted out of the waveguide by the first integrated grating 402 (which also provides beam expansion in the first direction). FIG. 4C shows the combined paths of FIGS. 4A-4B with the integrated gratings overlaid. FIG. 4C also shows the partial overlapping nature of the integrated gratings along the paths of the rays. As can readily be appreciated, such configurations can be modified as appropriate depending on the specific requirements of a given application. Gratings of various shapes can be utilized. An integrated grating can include two multiplexed gratings, one providing the function of a traditional fold grating and another for extracting the light similar to a traditional output grating. Each of the two multiplexed gratings within a single integrated grating can be configured to act on different portions of light bifurcated by the input configuration. In a number of embodiments, the two multiplexed gratings within a single integrated grating can have different shapes—i.e., certain areas of one or both of the gratings are not multiplexed. In some embodiments, more than two gratings are multiplexed for a single integrated grating. In many embodiments, the integrated gratings are multiplexed in a single grating layer. In several embodiments, the integrated gratings are fully multiplexed or overlapped. In other embodiments, only portions of the integrated gratings are multiplexed overlapped.

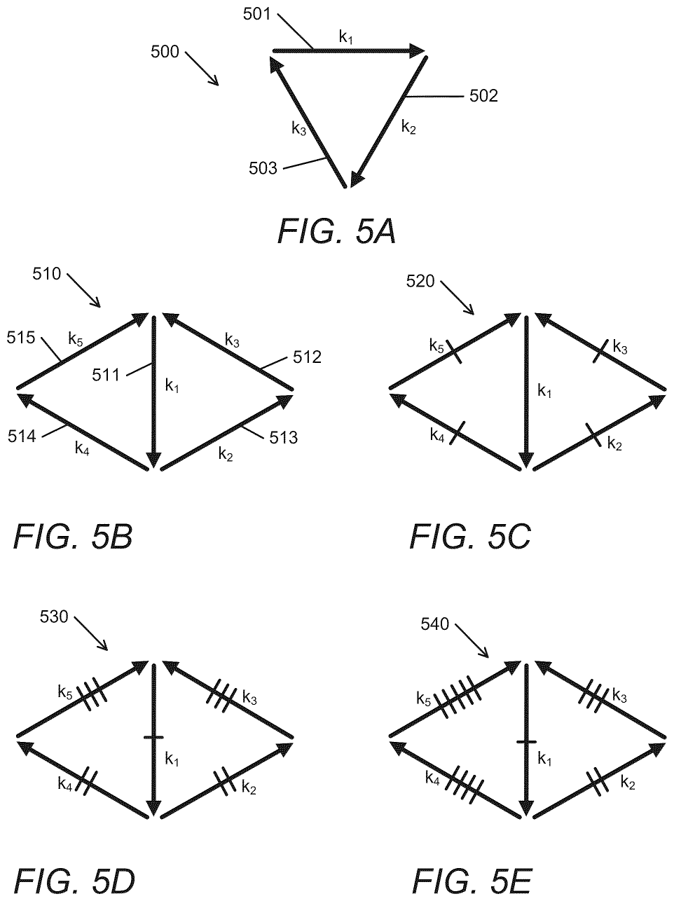

As described above, grating architectures including those implementing integrated gratings can be described and visualized using grating vectors. In many embodiments, three grating vectors, which can represent traditional input, fold, and output functions, can be implemented with a substantially zero resultant vector. FIG. 5A conceptually illustrates a grating vector configuration with a substantially zero resultant vector in accordance with an embodiment of the invention. As shown, the configuration 500 includes three grating vectors 501-503 represented as k₁, k₂, and k₃, respectively. With three grating vectors, configurations having a substantially zero resultant vector can provide various triangular configurations, such as but not limited to equilateral triangles, isosceles triangles, and scalene triangles. In the case of architectures utilizing integrated gratings, more than one triangular configuration can be visualized. FIG. 5B conceptually illustrates one such embodiment. As shown, the configuration 510 illustrates two triangular configurations. One triangular configuration is formed by grating vectors k₁, k₂, and k₃ (511-513), and a second configuration is formed by grating vectors k₁, k₄, and k₅ (511, 514, and 515). In the illustrative embodiment, grating vector k₁ represents the function of the input coupler, grating vectors k₂ and k₅ represent the functions of a first integrated grating, and grating vectors k₄ and k₅ represent the functions of a second integrated grating.

In many embodiments, the grating vector configuration implemented can include various triangular configurations. Typically, the magnitudes of the grating vectors can dictate the resulting triangular configuration. In some embodiments, an equilateral triangular configuration is implemented where all grating vectors are of similar, or substantially similar, magnitude. In cases where integrated gratings are implemented, the configuration can include two triangular configurations. In a number of embodiments, the grating vector configuration includes at least one isosceles triangle where at least two of the grating vectors have similar, or substantially similar, magnitudes. FIG. 5C conceptually illustrates a grating vector configuration with two isosceles triangles in accordance with an embodiment of the invention. As shown, the configuration 520 forms two isosceles triangles due to grating vectors k₂ k₅ having similar magnitudes. In several embodiments, the grating configuration includes at least one scalene triangle. FIG. 5D conceptually illustrates a grating vector configuration with two scalene triangles in accordance an embodiment of the invention. As shown, the configuration 530 forms two scalene triangles. In the illustrative embodiment, the two scalene triangles are mirrored—i.e., grating vectors k₂ and k₄ are equal in magnitude, and grating vectors k₅ and k₅ are equal in magnitude. FIG. 5E conceptually illustrates a grating vector configuration with two different scalene triangles in accordance with an embodiment of the invention. As shown, the configuration 540 includes two different scalene triangles with grating vectors k₂ k₅ having different magnitudes.

Although FIGS. 5A-5E illustrate specific grating vector configurations, various other configurations can be implemented as appropriate depending on the specific requirements of a given application. For example, in some embodiments, the input coupler is implemented to have two different grating vectors. Such configurations utilize an input grating having two different grating prescriptions, which can implemented using overlapping or multiplexed grating prescriptions. In the embodiments illustrated in FIGS. 5B-5E, the configurations shown can be due to the implementation of integrated gratings. In many embodiments, grating vectors k₂ and k₅ represent the functions of a first integrated grating, and grating vectors k₄ and k₅ represent the functions of a second integrated grating. In several embodiments, each grating vector kᵢ represent a different grating prescription. For example, many grating architectures in accordance with various embodiments of the invention can implement integrated gratings that each contain two different grating prescriptions. In such cases, grating vectors k₂ and k₅ can respectively represent the two different grating prescriptions of a first integrated grating, and grating vectors k₄ and k₅ can respectively represent the two different grating prescriptions of a second integrated grating.

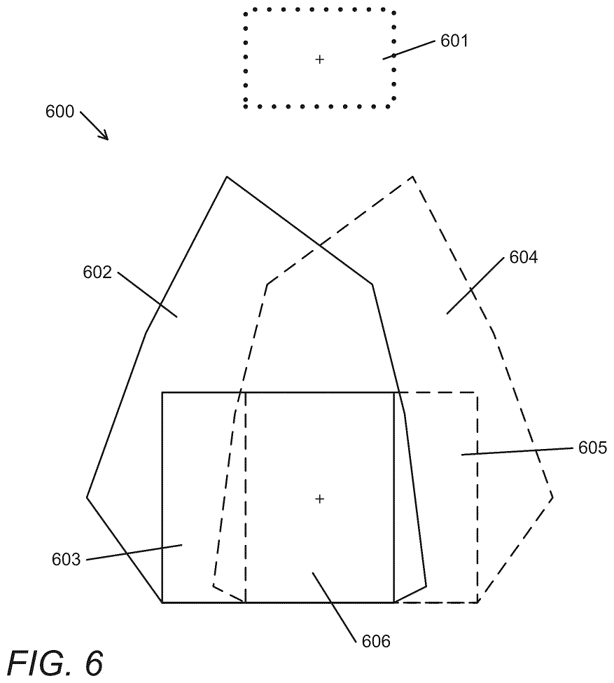

FIG. 6 conceptually illustrates a schematic plan view of a grating architecture 600 having an input grating and integrated gratings in accordance with an embodiment of the invention. As shown, the grating architecture 600 includes an input coupler 601. The input coupler 601 can be a Bragg grating or a surface relief grating. In many embodiments, the input coupler 601 includes at least two gratings. In such embodiments, individual input gratings can be configured to couple in different portions of input light, which can be based on angular or spectral characteristics. In some embodiments, the input couple 601 includes two overlapped gratings. In other embodiments, the input coupler 601 includes two multiplexed gratings. The grating architecture 600 further includes first (bold lines) and second (dashed lines) integrated gratings. In the illustrative embodiment, the first integrated grating includes a first grating 602 having a first grating prescription and a second grating 603 having a second grating prescription. As shown, the second grating 603 is smaller than the first grating 602 and can be entirely multiplexed within the volume of the first grating 602. In some embodiments, the first and second gratings 602,603 are overlapped across different grating layers. In several embodiments, the first and second gratings 602,603 are adjacent or nearly adjacent one another and are neither overlapped nor multiplexed. In a number of embodiments, the first and second gratings 602,603 have the same clock angles but different grating prescriptions.

In many embodiments, the configuration of the first integrated grating is applied similarly to the second integrated grating but flipped about an axis. For example, the illustrative embodiment in FIG. 6 shows the second integrated grating having third 604 and fourth 605 gratings with shapes corresponding to the first and second gratings 602,603, respectively. The third grating 604 has a third grating prescription, and the fourth grating 605 has a fourth grating prescription. Similar to the first integrated grating, the third and fourth gratings 604,605 can have the same clock angles but different grating prescriptions. In a number of embodiments, the first and second gratings 602,603 are clocked at an angle different from the third and fourth gratings 604,605. Again, the overlapping and multiplexing nature of the third and fourth gratings 604,605 can be implemented in a similar manner as the first and second gratings 602,603.

In the illustrative embodiment of FIG. 6, the first and third integrated gratings are partially overlapped with one another such that the second and fourth gratings 603,605 are also partially overlapped. In the illustrative embodiment, the second and fourth gratings 603,605 are multiplexed within the first and third gratings 602,604, and, as such, the waveguide architecture includes an area 606 where four grating prescriptions are active. In embodiments where the first and second integrated gratings are implemented in a single layer, area 606 would contain four multiplexed gratings. In other embodiments, the first and second integrated gratings are implemented across different grating layers.

During operation, input light incident on the input grating 601 can be bifurcated into two portions of light traveling in TIR paths within the waveguide. One portion can be directed towards the first grating 602 while the other portion can be directed towards the third grating 604. The first grating 602 can be configured to provide beam expansion in a first direction for incident light and to redirect the incident light towards the fourth grating 605. The fourth grating 605 can be configured to provide beam expansion in a second direction for incident light and to extract the light out of the waveguide. On the other hand, the third grating 604 can be configured to provide beam expansion in the second direction for incident light and to redirect the incident light towards the second grating 603. The second grating 603 can be configured to provide beam expansion in the first direction for incident light and to extract the light out of the waveguide.

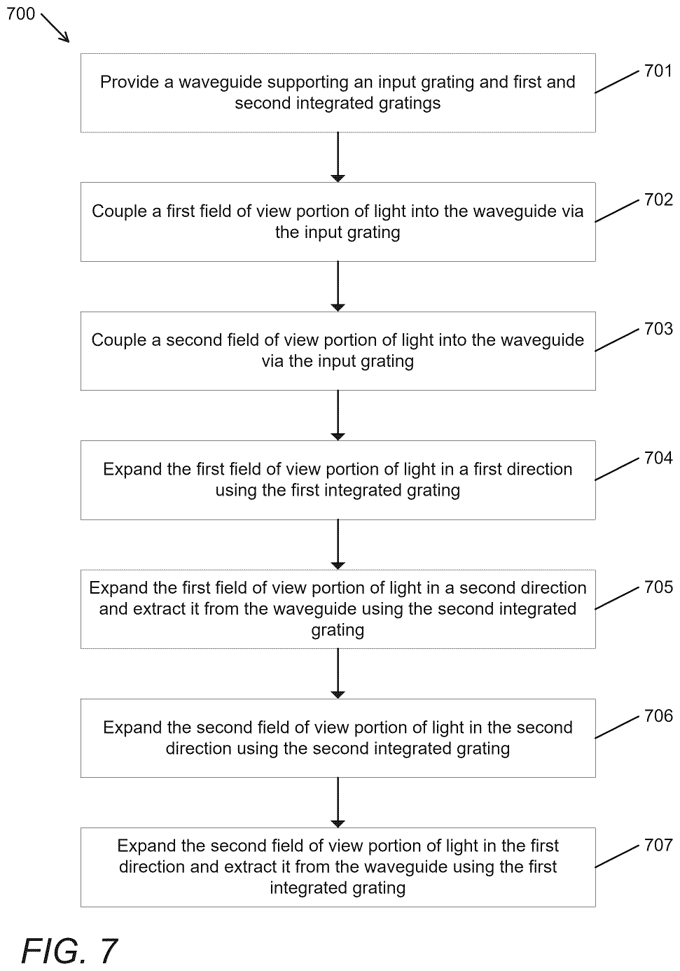

FIG. 7 shows a flow diagram conceptually illustrating a method of displaying an image in accordance with an embodiment of the invention. Referring to the flow diagram, the method 700 includes providing (701) a waveguide supporting an input grating, a first integrated grating, and a second integrated grating. In many embodiments, the first integrated grating partially overlaps the second integrated grating. In some embodiments, the integrated gratings are fully overlapped. The first and second integrated gratings can include multiplexed pairs of different K-vector gratings. A first field-of-view portion can be coupled (702) into the waveguide via the input grating and directed towards the first integrated grating. A second field-of-view portion can be coupled (703) into the waveguide via the input grating and directed towards the second integrated grating. The first field-of-view portion light can be expanded (704) in a first direction using the first integrated grating. The first field-of-view portion light can be expanded in a second direction and extracted (705) from the waveguide using the second integrated grating. The second field-of-view portion light can be expanded in the second direction (706) using the second integrated grating. The second field-of-view portion light can be expanded in the first direction and extracted (707) from the waveguide using the first integrated grating.

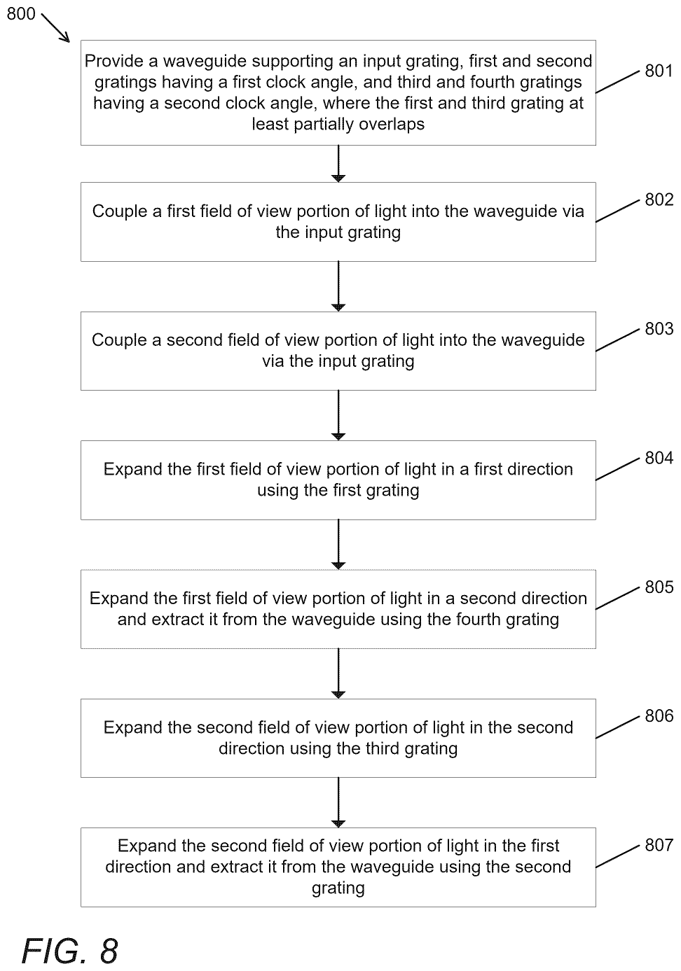

As described in the sections above, integrated gratings can be implemented in a variety of different ways. In many embodiments, an integrated grating is implemented with two gratings that have the same clock angle but different grating prescriptions. In further embodiments, the two gratings are multiplexed. FIG. 8 shows a flow diagram conceptually illustrating a method of displaying an image utilizing integrated gratings containing multiple gratings in accordance with an embodiment of the invention. Referring to the flow diagram, the method 800 includes providing (801) a waveguide supporting an input grating, first and second gratings having a first clock angle, and third and fourth gratings having a second clock angle, where the first and third grating at least partially overlaps. In many embodiments, the first integrated grating partially overlaps the second integrated grating. In some embodiments, the integrated gratings are fully overlapped. The first and second integrated gratings can include multiplexed pairs of different K-vector gratings. A first field-of-view portion can be coupled (802) into the waveguide via the input grating and directed towards the first grating. A second field-of-view portion can be coupled (803) into the waveguide via the input grating and directed towards the third grating. The first field-of-view portion light can be expanded (804) in a first direction using the first grating and redirected towards the fourth grating. The first field-of-view portion light can be expanded in a second direction and extracted (805) from the waveguide using the fourth grating. The second field-of-view portion light can be expanded in the second direction (806) using the third grating and redirected towards the second grating. The second field-of-view portion light can be expanded in the first direction and extracted (807) from the waveguide using the second grating.

Although FIGS. 6-8 illustrate specific waveguide configurations and methods of displaying an image, many different methods can be implemented in accordance with various embodiments of the invention. For example, in some embodiments, more than one input grating is utilized. In other embodiments, the input configuration includes a prism. Such methods and implemented waveguides can also be configured to improve performance and/or provide various different functions. In many embodiments, the waveguide apparatus includes at least one grating with spatially-varying pitch. In some embodiments, each grating has a fixed K vector. In a number of embodiments, at least one of the gratings is a rolled k-vector grating according to the embodiments and teachings disclosed in the cited references. Rolling the K-vectors can allow the angular bandwidth of the grating to be expanded without the need to decrease the grating thickness or to utilize multiple grating layers. In some embodiments a rolled K-vector grating includes a waveguide portion containing discrete grating elements having differently aligned K-vectors. In some embodiments, a rolled K-vector grating comprises a waveguide portion containing a single grating element within which the K-vectors undergo a smooth monotonic variation in direction. In some of the embodiments describe rolled K-vector gratings are used to input light into the waveguide. In some embodiments, waveguides having two integrated gratings can be implemented as single-layered or multi-layered waveguides. In several embodiments, a multi-layered waveguide is implemented with more than two integrated gratings. As can readily be appreciated, the specific architecture and configuration implemented can depend on a number of different factors. In some embodiments, the position of the input grating relative to the integrated gratings can be dictated by various factors, including but not limited to projector relief and the input pupil diameter and vergence. In many applications, it is desirable for the distance between the input grating and the integrated gratings to be minimized to provide a waveguide having a small form factor. The field ray angle paths required to fill the eyebox typically dominate the waveguide height. In many cases, the height of waveguide grows non-linearly with projector relief. In some embodiments, the pupil diameter does not have a significant impact on the footprint of the waveguide. A converging or diverging pupil can be used to reduce the local angle response at any location on the input grating.

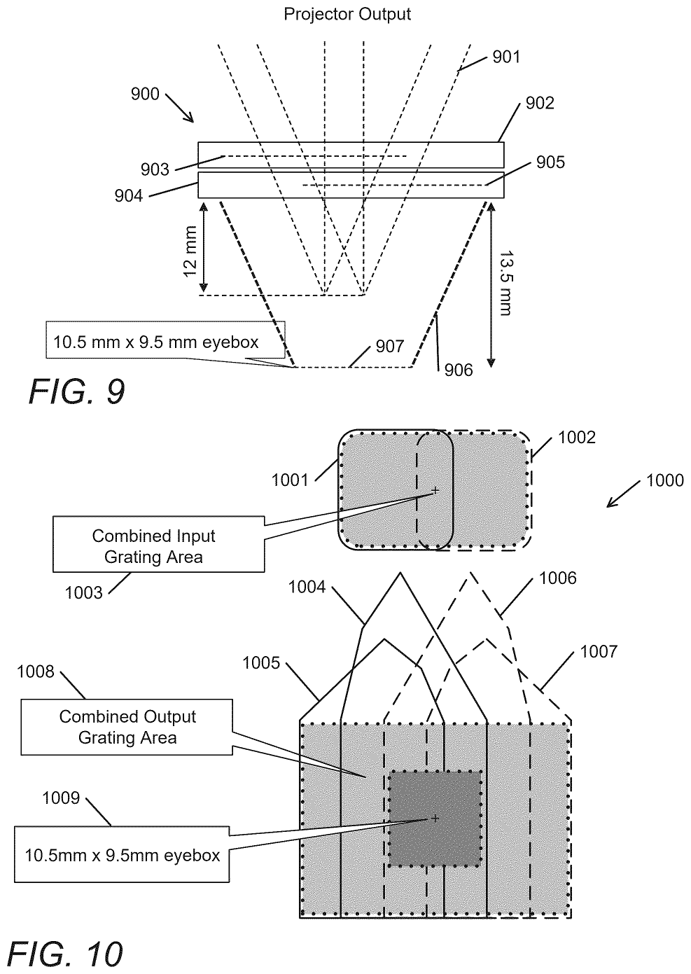

In some embodiments, the waveguide configuration implemented can depend on the configuration of the input image generator/projector. FIG. 9 conceptually illustrates a profile view 900 of two overlapping waveguide portions implementing integrated gratings in accordance with an embodiment of the invention. In the illustrative embodiment, the two-layered waveguide is designed for a high field-of-view application implemented with a converging projector pupil input beam, indicated by rays 901. As shown, the apparatus includes a first waveguide 902 containing a first grating layer 903 having a first set of two integrated gratings and a second waveguide 904 containing a second grating layer 905 having a second set of two integrated gratings that partially overlaps the first set of two integrated gratings. The grating layers 903,905 having integrated gratings can operate according to the principles discussed in the sections above. The output beam from the waveguides is generally indicated by rays 906 intersecting the eyebox 907. In the illustrated embodiment, the eyebox has dimensions 10.5 mm.×9.5 mm., an eye relief of 13.5 mm, and a laser projector to waveguide separation of 12 mm. As can readily be appreciated, such dimensions and specifications can be specifically tailored depending on the requirements of a given application.

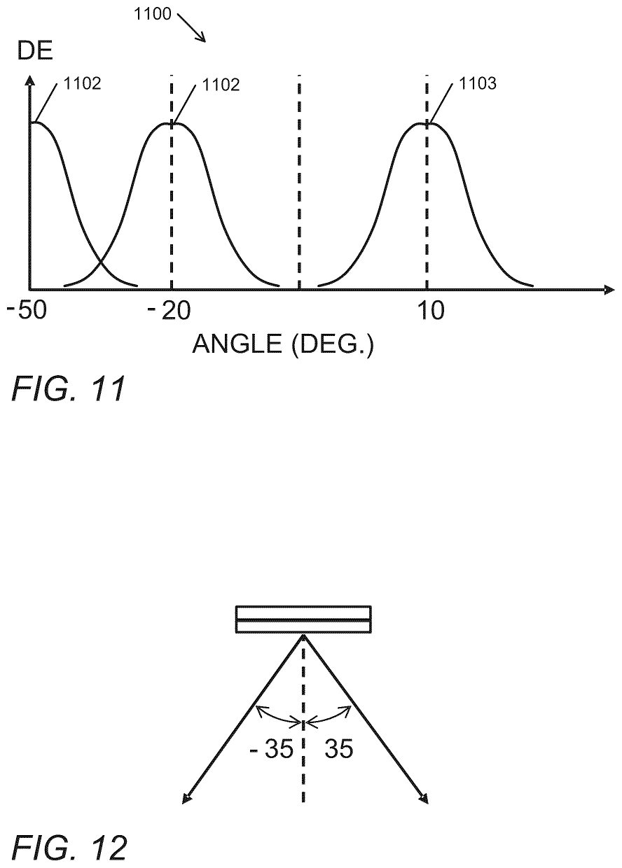

FIG. 10 conceptually illustrates a schematic plan view 1000 of a grating architecture having two sets of integrated gratings in accordance with an embodiment of the invention. As shown, the grating configuration includes first and second input gratings 1001, 1002, forming the combined input grating area 1003 indicated by the shaded area. In some embodiments, each of the input gratings includes a set of multiplexed or overlapping gratings. The grating configuration further includes a first set of grating structures having first and second integrated gratings 1004,1005 and a second set of grating structures having third and fourth integrated gratings 1006,1007. In the illustrative embodiment, each set of integrated gratings is shaped and disposed asymmetrically. Such configurations can be implemented as appropriate depending on several factors. In the embodiment of FIG. 10, the asymmetrical grating architecture can be implemented for operation with a converging projector pupil configuration, such as the one shown in FIG. 9. Furthermore, different grating characteristics can be implemented and tuned for different applications. FIG. 11 conceptually illustrates a plot 1100 of diffraction efficiency versus angle for a waveguide for diffractions occurring at different field-of-view angles in accordance with an embodiment of the invention. As shown, the waveguide is tuned to have three different peak diffraction efficiencies, with two different peaks 1101,1102 for the “fold” interaction and one 1103 for the “output.” In some embodiments, light undergoes a dual interaction within the grating. Such gratings can be designed to have high diffraction efficiencies for two different incident angles. Turning back to FIG. 10, the first and second set of grating structures can be implemented as partially overlapping structures, forming a combined output grating area 1008 as indicated by the shaded area. The eyebox 1009 is overlaid on the drawing and is indicated by the dark shaded area. In the illustrative embodiment, the waveguide apparatus is configured to provide a FOV of 120 degrees diagonal. As shown in FIGS. 9-10, in some embodiments, displays providing a FOV of 120 degrees diagonal can be configured with a projector to waveguide distance of 12 mm and an eye relief of 13.5 mm., which is compatible with many glasses inserts. In some embodiments, the display provides an eyebox of 10.5 mm.×9.5 mm., which can provide easy wearability. FIG. 12 shows the viewing geometry of such a waveguide. As can readily be appreciated, the grating configuration illustrated by FIG. 10 can be implemented in a variety of waveguide architectures. In some embodiments, both input gratings and both sets of grating structures are implemented in a single grating layer, with the overlapping portions multiplexed. In several embodiments, the first input grating and the first set of grating structures are implemented in a first grating layer while the second input grating and the second set of grating structures are implemented in a second grating layer. In a number of embodiments, the first, second, third, and fourth integrated gratings are implemented across four grating layers.

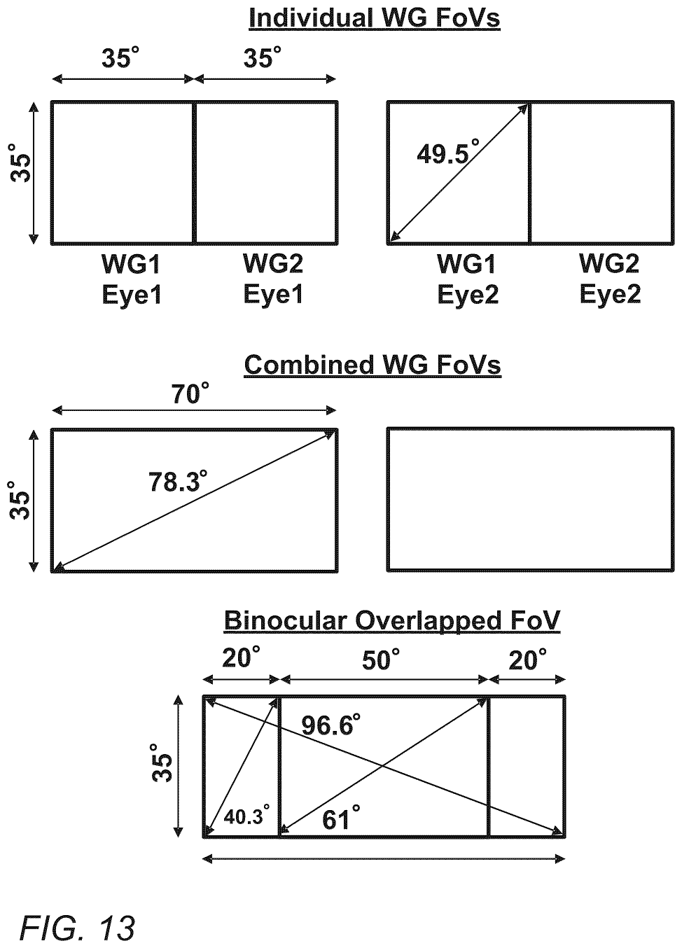

FIG. 13 conceptually illustrates the field-of-view geometry for a binocular display with binocular overlap between the left and right eye images provided by a waveguide in accordance with an embodiment of the invention. Binocular displays utilizing various grating architectures, such as the one described in FIGS. 9-10. can be implemented. In the illustrated embodiment, the waveguide is a color waveguide that includes a stack of four waveguides: two blue-green layers and two green-red layers. Each of the waveguides can provide a field-of-view of 35° h×35° v (˜50° diagonal) for a single-color band, yielding 70° h×35° v (˜78° diagonal) field-of-view for each color band. Each waveguide set for the left and right eyes can be overlapped by 50° horizontally to achieve ˜100° diagonal binocular field-of-view. As can readily be appreciated, various binocular configurations can be implemented as appropriated depending on the specific requirements of a given application. In many embodiments, the waveguide is raked at an angle of at least 5°, which can facilitate the implementation of some binocular overlapped field-of-view applications. In further embodiments, the waveguide is raked at an angle of at least 10°. In some embodiments, the field-of-views for both the left and right eyes are completely overlapped.

### Other Waveguide Embodiments

In some embodiments, a prism may be used as an alternative to the input grating. In many embodiments, this can require that an external grating is provided for grating vector closure purposes. In several embodiments, the external grating may be disposed on the surface of the prism. In some embodiments, the external grating may form part of a laser despeckler disposed in the optical train between the laser projector and the input prims. The use of a prism to couple light into a waveguide has the advantage of avoiding the significant light loss and restricted angular bandwidth resulting from the use of a rolled K-vector grating. A practical rolled K-vector input grating typically cannot match the much large angular bandwidth of the fold grating, which can be around 40 degrees or more.

Although the drawings may indicate a high degree of symmetry in the grating geometry and layout of the gratings in the different wavelength channels, the grating prescriptions and footprints can be asymmetric. The shapes of the input, fold, or output gratings can depend on the waveguide application and could be of any polygonal geometry subject to factors such as the required beam expansion, output beam geometry, beam uniformity, and ergonomic factors.

In some embodiments, directed at displays using unpolarized light sources, the input gratings can combine gratings orientated such that each grating diffracts a particular polarization of the incident unpolarized light into a waveguide path. Such embodiments may incorporate some of the embodiments and teachings disclosed in the PCT application PCT/GB2017/000040 “METHOD AND APPARATUS FOR PROVIDING A POLARIZATION SELECTIVE HOLOGRAPHIC WAVGUIDE DEVICE” by Waldern et al., the disclosure of which is incorporated herein in by reference in its entirety. The output gratings can be configured in a similar fashion so that the light from the waveguide paths is combined and coupled out of the waveguide as unpolarized light. For example, in some embodiments, the input grating and output grating each combine crossed gratings with peak diffraction efficiency for orthogonal polarizations states. In a number of embodiments, the polarization states are S-polarized and P-polarized. In several embodiments, the polarization states are opposing senses of circular polarization. The advantage of gratings recorded in liquid crystal polymer systems, such as SBGs, in this regard is that owing to their inherent birefringence, they exhibit strong polarization selectivity. However, other grating technologies that can be configured to provide unique polarization states can also be used.

In some embodiments using gratings recorded in liquid crystal polymer material systems, at least one polarization control layer overlapping at least one of the fold gratings, input gratings, or output gratings may be provided for the purposes of compensating for polarization rotation in any the gratings, particularly the fold gratings, which can result in polarization rotation. In many embodiments, all of the gratings are overlaid by polarization control layers. In a number of embodiments, polarization control layers are applied to the fold gratings only or to any other subset of the gratings. The polarization control layer may include an optical retarder film. In some embodiments based on HPDLC materials, the birefringence of the gratings may be used to control the polarization properties of the waveguide device. The use of the birefringence tensor of the HPDLC grating, K-vectors, and grating footprints as design variables opens up the design space for optimizing the angular capability and optical efficiency of the waveguide device. In some embodiments, a quarter wave plate can be disposed on a glass-air interface of the wave guide rotates polarization of a light ray to maintain efficient coupling with the gratings. In further embodiments, the quarter wave plate is a coating that is applied to substrate waveguide. In some waveguide display embodiments, applying a quarter wave coating to a substrate of the waveguide may help light rays retain alignment with the intended viewing axis by compensating for skew waves in the waveguide. In some embodiments, the quarter wave plate may be provided as a multi-layer coating.

As used in relation to any of the embodiments described herein, the term grating may encompass a grating that includes a set of gratings. For example, in some embodiments, the input grating and output grating each include two or more gratings multiplexed into a single layer. It is well established in the literature of holography that more than one holographic prescription can be recorded into a single holographic layer. Methods for recording such multiplexed holograms are well known to those skilled in the art. In some embodiments, the input grating and output grating may each include two overlapping gratings layers that are in contact or vertically separated by one or more thin optical substrate. In several embodiments, the grating layers are sandwiched between glass or plastic substrates. In a number of embodiments, two or more such gratings layers may form a stack within which total internal reflection occurs at the outer substrate and air interfaces. In some embodiments, the waveguide may include just one grating layer. In many embodiments, electrodes may be applied to faces of the substrates to switch gratings between diffracting and clear states. The stack may further include additional layers such as beam splitting coatings and environmental protection layers.

In some embodiments, the fold grating angular bandwidth can be enhanced by designing the grating prescription to facilitate dual interaction of the guided light with the grating. Exemplary embodiments of dual interaction fold gratings are disclosed in U.S. patent application Ser. No. 14/620,969 entitled “WAVEGUIDE GRATING DEVICE.”

Advantageously, to improve color uniformity, gratings for use in the invention can be designed using reverse ray tracing from the eyebox to the input grating via the output grating and fold grating. This process allows the required physical extent of the gratings, in particular the fold grating, to be identified. Unnecessary grating real-state which contribute to haze can be eliminated. Ray paths can be optimized for red, green, and blue, each of which follow slightly different paths because of dispersion effects between the input and output gratings via the fold grating.

In many embodiments, the gratings are holographic gratings, such as a switchable or non-switchable Bragg Gratings. In some embodiments, gratings embodied as SBGs can be Bragg gratings recorded in a holographic polymer dispersed liquid crystal (e.g., a matrix of liquid crystal droplets), although SBGs may also be recorded in other materials. In several embodiments, the SBGs are recorded in a uniform modulation material, such as POLICRYPS or POLIPHEM having a matrix of solid liquid crystals dispersed in a liquid polymer. The SBGs can be switching or non-switching in nature. In some embodiments, at least one of the input, fold, and output gratings may be electrically switchable. In many embodiments, it is desirable that all three grating types are passive, that is, non-switching. In its non-switching form, an SBG has the advantage over conventional holographic photopolymer materials of being capable of providing high refractive index modulation due to its liquid crystal component. Exemplary uniform modulation liquid crystal-polymer material systems are disclosed in United State Patent Application Publication No.: US2007/0019152 by Caputo et al and PCT Application No.: PCT/EP2005/006950 by Stumpe et al., both of which are incorporated herein by reference in their entireties. Uniform modulation gratings are characterized by high refractive index modulation (and hence high diffraction efficiency) and low scatter. In some embodiments, the input coupler, the fold grating, and the output grating are recorded in a reverse mode HPDLC material. Reverse mode HPDLC differs from conventional HPDLC in that the grating is passive when no electric field is applied and becomes diffractive in the presence of an electric field. The reverse mode HPDLC may be based on any of the recipes and processes disclosed in PCT Application No.: PCT/GB2012/000680, entitled “IMPROVEMENTS TO HOLOGRAPHIC POLYMER DISPERSED LIQUID CRYSTAL MATERIALS AND DEVICES.” The gratings may be recorded in any of the above material systems but used in a passive (non-switching) mode. The advantage of recording a passive grating in a liquid crystal polymer material is that the final hologram benefits from the high index modulation afforded by the liquid crystal. Higher index modulation translates to high diffraction efficiency and wide angular bandwidth. The fabrication process is identical to that used for switched but with the electrode coating stage being omitted. LC polymer material systems are highly desirable in view of their high index modulation. In some embodiments, the gratings are recorded in HPDLC but are not switched.

In many embodiments, two spatially separated input couplers may be used to provide two separate waveguide input pupils. In some embodiments, the input coupler is a grating. In several embodiments, the input coupler is a prism. In embodiments using an input coupler prism based on prisms only, the conditions for grating reciprocity can be addressed using the pitch and clock angles of the fold and output gratings.

In many embodiments, the source of data modulated light used with the above waveguide embodiments includes an Input Image Node (“IIN”) incorporating a microdisplay. The input grating can be configured to receive collimated light from the IIN and to cause the light to travel within the waveguide via total internal reflection between the first surface and the second surface to the fold grating. Typically, the IIN integrates, in addition to the microdisplay panel, a light source and optical components needed to illuminate the display panel, separate the reflected light, and collimate it into the required FOV. Each image pixel on the microdisplay can be converted into a unique angular direction within the first waveguide. The instant disclosure does not assume any particular microdisplay technology. In some embodiments, the microdisplay panel can be a liquid crystal device or a MEMS device. In several embodiments, the microdisplay may be based on Organic Light Emitting Diode (OLED) technology. Such emissive devices would not require a separate light source and would therefore offer the benefits of a smaller form factor. In some embodiments, the IIN may be based on a scanned modulated laser. The IIN projects the image displayed on the microdisplay panel such that each display pixel is converted into a unique angular direction within the substrate waveguide according to some embodiments. The collimation optics contained in the IIN may include lens and mirrors, which may be diffractive lenses and mirrors. In some embodiments, the IIN may be based on the embodiments and teachings disclosed in U.S. patent application Ser. No. 13/869,866 entitled “HOLOGRAPHIC WIDE-ANGLE DISPLAY,” and U.S. patent application Ser. No. 13/844,456 entitled “TRANSPARENT WAVEGUIDE DISPLAY.” In several embodiments, the IIN contains beamsplitter for directing light onto the microdisplay and transmitting the reflected light towards the waveguide. In many embodiments, the beamsplitter is a grating recorded in HPDLC and uses the intrinsic polarization selectivity of such gratings to separate the light illuminating the display and the image modulated light reflected off the display. In some embodiments, the beam splitter is a polarizing beam splitter cube. In a number of embodiments, the IIN incorporates a despeckler. The despeckler can be a holographic waveguide device based on the embodiments and teachings of U.S. Pat. No. 8,565,560 entitled “LASER ILLUMINATION DEVICE.” The light source can be a laser or LED and can include one or more lenses for modifying the illumination beam angular characteristics. The image source can be a micro-display or laser-based display. LED can provide better uniformity than laser. If laser illumination is used, there is a risk of illumination banding occurring at the waveguide output. In some embodiments, laser illumination banding in waveguides can be overcome using the techniques and teachings disclosed in U.S. Provisional Patent Application No. 62/071,277 entitled “METHOD AND APPARATUS FOR GENERATING INPUT IMAGES FOR HOLOGRAPHIC WAVEGUIDE DISPLAYS.” In some embodiments, the light from the light source is polarized. In one or more embodiments, the image source is a liquid crystal display (LCD) micro display or liquid crystal on silicon (LCoS) micro display.

The principles and teachings of the invention in combination with other waveguide inventions by the inventors as disclosed in the reference documents incorporated by reference herein may be applied in many different display and sensor devices. In some embodiments directed at displays, a waveguide display according to the principles of the invention can be combined with an eye tracker. In some embodiments, the eye tracker is a waveguide device overlaying the display waveguide and is based on the embodiments and teachings of PCT/GB2014/000197 entitled “HOLOGRAPHIC WAVEGUIDE EYE TRACKER,” PCT/GB2015/000274 entitled “HOLOGRAPHIC WAVEGUIDE OPTICALTRACKER,” and PCT Application No.: GB2013/000210 entitled “APPARATUS FOR EYE TRACKING.”

In some embodiments of the invention directed at displays, a waveguide display according to the principles of the invention further includes a dynamic focusing element. The dynamic focusing element may be based on the embodiments and teachings of U.S. Provisional Patent Application No. 62/176,572 entitled “ELECTRICALLY FOCUS TUNABLE LENS.” In some embodiments, a waveguide display according to the principles of the invention can further include a dynamic focusing element and an eye tracker, which can provide a light field display based on the embodiments and teachings disclosed in U.S. Provisional Patent Application No. 62/125,089 entitled “HOLOGRAPHIC WAVEGUIDE LIGHT FIELD DISPLAYS.”

In some embodiments of the invention directed at displays, a waveguide according to the principles of the invention may be based on some of the embodiments of U.S. patent application Ser. No. 13/869,866 entitled “HOLOGRAPHIC WIDEANGLE DISPLAY,” and U.S. patent application Ser. No. 13/844,456 entitled “TRANSPARENT WAVEGUIDE DISPLAY.” In some embodiments, a waveguide apparatus according to the principles of the invention may be integrated within a window, for example a windscreen-integrated HUD for road vehicle applications. In some embodiments, a window-integrated display may be based on the embodiments and teachings disclosed in United States Provisional Patent Application No.: PCT Application No.: PCT/GB2016/000005 entitled “ENVIRONMENTALLY ISOLATED WAVEGUIDE DISPLAY.” In some embodiments, a waveguide apparatus may include gradient index (GRIN) wave-guiding components for relaying image content between the IIN and the waveguide. Exemplary embodiments are disclosed in PCT Application No.: PCT/GB2016/000005 entitled “ENVIRONMENTALLY ISOLATED WAVEGUIDE DISPLAY.” In some embodiments, the waveguide apparatus may incorporate a light pipe for providing beam expansion in one direction based on the embodiments disclosed in U.S. Provisional Patent Application No. 62/177,494 entitled “WAVEGUIDE DEVICE INCORPORATING A LIGHT PIPE.”

In many embodiments, a waveguide according to the principles of the invention provides an image at infinity. In some embodiments, the image may be at some intermediate distance. In some embodiments, the image may be at a distance compatible with the relaxed viewing range of the human eye. In many embodiments, this may cover viewing ranges from about 2 meters up to about 10 meters.

The construction and arrangement of the systems and methods as shown in the various exemplary embodiments are illustrative only. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. The present invention can incorporate the embodiments and teachings disclosed in U.S. Provisional Patent Application No. 62/778,239 “METHODS AND APPARATUSES FOR PROVIDING A SINGLE GRATING LAYER COLOR HOLOGRAPHIC WAVEGUIDE DISPLAY”, and the following US filings: U.S. Ser. No. 14/620,969 “WAVEGUIDE GRATING DEVICE”; U.S. Ser. No. 15/468,536 “WAVEGUIDE GRATING DEVICE”; Ser. No. 15/807,149 “WAVEGUIDE GRATING DEVICE”; and Ser. No. 16/178,104 “WAVEGUIDE GRATING DEVICE”, by Popovich et al., which are incorporated herein in by reference in their entireties. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A waveguide display, comprising:
a source of light; and
a first waveguide comprising:
a grating structure comprising first and second gratings; and
an input coupler configured to:
couple a first field-of-view portion of light from said source of light into said first waveguide and towards said first grating; and
couple a second field-of-view portion of light from said source of light into said first waveguide and towards said second grating;
wherein:
said first grating is configured to:
provide beam expansion in a first direction for said first field-of-view portion of light; and
provide beam expansion in said first direction and beam extraction towards a viewer for said second field-of-view portion of light;
said second grating is configured to:
provide beam expansion in a second direction for said second field-of-view portion of light; and
provide beam expansion in said second direction and beam extraction towards a viewer for said first field-of-view portion of light;
said input coupler, said first grating, and said second grating each comprises a grating vector; and
said grating vectors of said input coupler, said first grating, and said second grating provide a resultant vector with substantially zero magnitude, wherein:
a light extraction region for providing beam extraction for said second field-of-view portion of light and providing extraction for said first field-of-view portion of light is formed by overlapping portions of said first grating and said second grating, wherein at least one light path from said input coupler to said light extraction region interacts with a portion of said first grating not in overlap with said second grating, and wherein at least one light path from said input coupler to said light extraction region interacts with a portion of said second grating not in overlap with said first grating.

2. The waveguide display of claim 1, wherein:
said first grating comprises first and second grating prescriptions; and
said second grating comprises third and fourth grating prescriptions; wherein:
said first grating prescription is configured to provide said beam expansion in said first direction for said first field-of-view portion of light;
said second grating prescription is configured to provide beam expansion in said first direction and beam extraction towards a viewer for said second field-of-view portion of light;
said third grating prescription is configured to provide said beam expansion in said second direction for said second field-of-view portion of light; and
said fourth grating prescription is configured to provide said beam expansion in said second direction and beam extraction towards a viewer for said first field-of-view portion of light.

3. The waveguide display of claim 2, wherein said first and second grating prescriptions are at least partially multiplexed; and said third and fourth grating prescriptions are at least partially multiplexed.

4. The waveguide display of claim 3, wherein said first grating at least partially overlaps said second grating.

5. The waveguide display of claim 4, wherein:
said first waveguide comprises first and second grating layers;
said first grating is disposed within said first grating layer; and
said second grating is disposed within said second grating layer.

6. The waveguide display of claim 5, wherein said first waveguide further comprises a transparent layer disposed between and adjacent said first and second grating layers.

7. The waveguide display of claim 6, further comprising a second waveguide; wherein said first waveguide is configured to couple in a first spectral band of light; and said second waveguide is configured to couple in a second spectral band of light.

8. The waveguide display of claim 1, wherein said input coupler comprises an input configuration selected from the group consisting of: an input prism; an input grating; first and second input gratings; and an input grating comprising two multiplexed grating prescriptions.

9. The waveguide display of claim 1, wherein said grating vector of said input coupler has a different magnitude than said grating vector of said first grating.

10. The waveguide display of claim 1, wherein said source of light provides at least two different wavelengths of light.

11. A method of displaying an image, the method comprising:
providing a waveguide display comprising a first waveguide supporting an input coupler and a grating structure comprising first and second gratings, wherein said input coupler, said first grating, and said second grating each comprises a grating vector, wherein said grating vectors of said input coupler, said first grating, and said second grating provide a resultant vector with substantially zero magnitude;
coupling a first field of view portion into said waveguide via said input coupler;
coupling a second field-of-view portion into said waveguide via said input coupler;
expanding said first field-of-view portion light in a first direction using said first grating;
expanding said first field-of-view portion light in a second direction and extracting it from said waveguide using said second grating;
expanding said second field-of-view portion light in said second direction using said second grating; and
expanding said second field of view portion light in said first direction and extracting it from said waveguide using said first grating, wherein:
extraction for said second field-of-view portion of light and extraction for said first field-of-view portion of light is accomplished by overlapping portions of said first grating and said second grating, wherein at least one light path from said input coupler to said light extraction region interacts with a portion of said first grating not in overlap with said second grating, and wherein at least one light path from said input coupler to said light extraction region interacts with a portion of said second grating not in overlap with said first grating.

12. The method of claim 11, wherein:
said first grating comprises first and second grating prescriptions; and
said second grating comprises third and fourth grating prescriptions; wherein:
said first field-of-view portion light is expanded in said first direction using said first grating prescription;
said second field-of-view portion light is expanded in said first direction and extracted from said waveguide using said second grating prescription;
said second field-of-view portion light is expanded in said second direction using said third grating prescription; and
said first field-of-view portion light is expanded in said second direction and extracted from said waveguide using said fourth grating prescription.

13. The method of claim 12, wherein said first and second grating prescriptions are at least partially multiplexed; and said third and fourth grating prescriptions are at least partially multiplexed.

14. The method of claim 13, wherein said first grating at least partially overlaps said second grating.

15. The method of claim 14, wherein:
said first waveguide comprises first and second grating layers;
said first grating is disposed within said first grating layer; and
said second grating is disposed within said second grating layer.

16. The method of claim 15, wherein said first waveguide further comprises a transparent layer disposed between and adjacent said first and second grating layers.

17. The method of claim 16, wherein said waveguide display further comprises a second waveguide; wherein said first waveguide is configured to couple in a first spectral band of light; and said second waveguide is configured to couple in a second spectral band of light.

18. The method of claim 11, wherein said input coupler comprises an input configuration selected from the group consisting of: an input prism; an input grating; first and second input gratings; and an input grating comprising two multiplexed grating prescriptions.

19. The method of claim 11, wherein said grating vector of said input coupler has a different magnitude than said grating vector of said first grating.

20. The method of claim 11, wherein said source of light provides at least two different wavelengths of light.
